(19) United States
(12) Patent Application Publication
(10) Pub. No.: US 2011/0210105 A1
(43) Pub. Date: Sep. 1, 2011

(54) LINK PROCESSING WITH HIGH SPEED BEAM DEFLECTION

(75) Inventors: Dmitry N. Romashko, Lexington, MA (US); Michael Plotkin, Newton, MA (US); Jonathan S. Ehrmann, Sudbury, MA (US); James J. Cordingley, Littleton, MA (US); Shepard D. Johnson, Andover, MA (US)

(73) Assignee: GSI GROUP CORPORATION, Bedford, MA (US)

(21) Appl. No.: 12/976,539

(22) Filed: Dec. 22, 2010

Related U.S. Application Data
(60) Provisional application No. 61/291,282, filed on Dec. 30, 2009.

(51) Int. Cl. B23K 26/00

(52) U.S. Cl. 219/121.72; 219/121.67

(57) ABSTRACT

Link processing systems and methods use controlled two dimensional deflection of a beam along an optical axis trajectory to process links positioned along and transverse to the trajectory during a pass of the optical axis along the trajectory. Predictive position calculations allow link blowing accuracy during constant velocity and accelerating trajectories.

### CROSS-REFERENCE TO RELATED APPLICATIONS

This application claims priority under 35 U.S.C. Section 119(e) to Provisional Application No. 61/291,282, filed on Dec. 30, 2009, which application is incorporated by reference in its entirety.

### BACKGROUND OF THE INVENTION

1. Field of the Invention

The present invention relates to the field of laser processing methods and systems, and specifically, to laser processing methods and systems for laser processing multi-material devices.

2. Description of the Related Art

Lasers can be used in the processing of microstructures in memory and integrated circuit devices. For example, laser pulses can be used to ablate conductive links or link portions in a memory device, such as DRAMs in order to substitute working redundant memory cells for defective memory cells during memory manufacture.

Recently, the use of new materials, such as aluminum, gold, and copper, coupled with the small geometry of these devices, have made the problem of link removal more difficult. Economics and device performance goals have driven the size for the DRAMs and logic devices to very small physical dimensions. Thus, it can be increasingly difficult to irradiate a target structure without damaging surrounding components such as the substrate and adjacent circuitry and links. Furthermore, as more links need to be processed for a given area of semiconductor circuitry, the time required to process a given die increases.

When a single laser pulse or burst of pulses is used to irradiate and sever each link designated for removal, the beam path of laser pulses may move relative to the substrate during the process of irradiation in an “on-the-fly” link blowing process. This relative movement may include moving the substrate and/or moving the beam, although substrate motion on an X-Y stage in conjunction with a vertically oriented and stationary beam is a currently common approach. In conventional laser processing systems, groups of arrayed microstructures are processed. The array may be links in a row, links in closely spaced rows, links in staggered rows and similar regularly spaced arrangements. The conventional processing is generally carried out with either an energy on demand system (e.g. pulse equalization) or an energy picking system (e.g. pulse picking). In the energy on demand system, an irradiation period is timed to coincide with a moving target and the processing rate is limited by a minimum period between energy on demand irradiation periods. In the energy picking system, the laser is pulsed in a continuously repeating sequence at a predetermined repetition rate (e.g. at a q-rate, pulse rate, or burst rate) and the arrayed microstructures in a group are moved synchronously with the repetition rate so that energy is available to process any microstructure in a particular group. The processing rate is limited by a period associated with the maximum repetition rate, and an acousto-optic device or other optical switching device blocks energy from reaching the substrate except when processing a selected synchronized target.

The conventional energy picking process is illustrated in FIGS. 1 and 2. A repeating sequence of laser pulses 1, for example pulses from a q-switched laser, pulses from a sequence of pulse bursts, or a sequence of temporally shaped pulses is generated at a predetermined repetition rate. A group of links 200 having a characteristic spacing d is put in motion relative to a processing head at a predetermined velocity V by moving a stage 100 under control of a control computer or logic 101. As adjacent links move relative to the processing head, there is an associated transit time T1 such that after a period equal to T1, the substrate has moved by an amount equal to the characteristic spacing of the links. Put another way, the link to link period at velocity V relative to the processing head is T1.

In a conventional processing system links and pulses are synchronized. T1 and the period of the laser pulse repetition rate (e.g. the pulse to pulse period of a q-switched laser controlled by trigger signals from the control computer 14) are made equal. With this method, a pulse is available to process every link. Pulses that are synchronized with links to be processed, such as links 200a, 200d, and 200f of FIG. 2, are allowed to reach the targets and process the respective links. Pulses that are synchronized with links that are to remain intact are blocked from reaching the targets by an energy control and energy control pulse selection system 102 of FIG. 1, as indicated by dashed circles in FIG. 2 where the beam would strike if it was not blocked.

It will be appreciated that the time required to process a given set of links within a group of a row or a column of links is approximately the number of links times the time period T1, which in these systems equals the laser pulse repetition rate. If the laser used has a maximum pulse rate of 50 kHz, for example, completing the pass of the beam across the 11 links of FIG. 1 will require at least 200 microseconds.

For further reference, the following co-pending U.S. applications and issued patents are assigned to the assignee of the present invention, describe many additional aspects of laser link blowing, and are hereby incorporated by reference in their entirety:
1. U.S. Pat. No. 6,144,118, entitled “High Speed Precision Positioning Apparatus”;
2. U.S. Pat. No. 6,181,728, entitled “Controlling Laser Polarization”;
3. U.S. Pat. No. 6,281,471, entitled “Energy Efficient, Laser-Based Method and System for Processing Target Material”;
4. U.S. Pat. No. 6,340,806, entitled “Energy-Efficient Method and System for Processing Target Material Using an Amplified, Wavelength-Shifted Pulse Train”;
5. U.S. Pat. No. 6,483,071, entitled “Method and System For Precisely Positioning A Waist of A Material-Processing Laser Beam To Process Microstructures Within A Laser-Processing Site”, filed 16 May 2000, and published as WO 0187534 A2, December, 2001;
6. U.S. Pat. No. 6,300,590, entitled “Laser Processing”;
7. U.S. Pat. No. 6,339,604, entitled “Pulse Control in Laser Systems;”
8. U.S. Pat. No. 6,639,177, entitled “Method and System For Processing One or More Microstructures of A Multi-Material Device;”
9. U.S. Pat. No. 6,951,995, entitled “Method and System for High Speed, Precise Micromachining an Array of Devices;”
10. U.S. Patent Publication 20020167581, entitled “Methods and Systems for Thermal-Based Laser Processing a Multi-Material Device.”
11. U.S. Patent Publication 20080029491, entitled “System and Method for Laser Processing at Non-Constant Velocities.”

### SUMMARY OF THE INVENTION

According to some aspects, a laser based system for processing target material on a substrate is provided. The system including a mechanical positioning system for moving the substrate along a processing trajectory relative to an aligned laser beam axis intersection position on or within the substrate, and a solid-state beam deflection system for addressing positions within an addressable field by deflecting the intersection position of the laser beam axis, the field including the aligned intersection position, the alignment relative to one or more features of the substrate, and the addressable field having an area and dimension relative to the aligned intersection position. A method of laser processing in the laser based system includes moving the substrate along the processing trajectory, deflecting the intersection position of the laser beam axis and the substrate to a position within the addressable field and offset from the trajectory, impinging, at the deflected intersection position onto target material according to an offset dimension, one or more laser pulses occurring within a processing period that is synchronized with the trajectory and a sequence of targets to be processed, wherein the trajectory and the sequence are determined based on target material locations, mechanical positioning parameters, and addressable field parameters, to generate the trajectory, the sequence of targets to be processed along the trajectory, and the corresponding offset dimensions.

According to some aspects a laser based system for processing target material on a substrate, the system including a mechanical positioning system for moving the substrate along a processing trajectory relative to an aligned laser beam axis intersection position on or within the substrate, and a solid-state beam deflection system for addressing positions within an addressable field by deflecting the intersection position of the laser beam axis, the field including the aligned intersection position, the alignment relative to one or more features of the substrate, and the addressable field having an area and dimension relative to the aligned intersection position. A method of laser processing in the laser based system includes moving the substrate along the processing trajectory, deflecting the intersection position of the laser beam axis and the substrate to a position within the addressable field and offset from the trajectory, controlling energy delivered to the target material within a predetermined tolerance range relative to a selected processing energy value, impinging, at the deflected intersection position onto target material according to an offset dimension, one or more laser pulses occurring within a processing period that is synchronized with the trajectory and a sequence of targets to be processed, wherein deflecting comprises simultaneously deflecting the laser beam axis in a first axis and in a second axis and controlling comprises setting a processing energy value and adjusting beam attenuation according to a calibration profile.

According to some aspects a laser based system for processing target material on a substrate, the system including a mechanical positioning system for moving the substrate along a processing trajectory relative to an aligned laser beam axis intersection position on or within the substrate, and a solid-state beam deflection system for addressing positions within an addressable field by deflecting the intersection position of the laser beam axis, the field including the aligned intersection position, the alignment relative to one or more features of the substrate, and the addressable field having an area and dimension relative to the aligned intersection position. A method of laser processing in the laser based system includes applying a first RF signal corresponding to a deflection angle to an acousto-optic beam deflector, measuring diffraction efficiency versus time after applying the RF signal and determining a minimum propagation delay interval to achieve diffraction efficiency within a specified tolerance, measuring diffraction efficiency versus time after terminating the RF signal at the end of an RF period and determining a minimum RF period to maintain diffraction efficiency within the specified tolerance, moving the substrate along the processing trajectory, deflecting the intersection position of the laser beam axis and the substrate to a position within the addressable field and offset from the trajectory by applying a second RF signal to the acousto-optic beam deflector using the minimum propagation delay and the minimum RF period, impinging, at the deflected intersection position onto target material according to an offset dimension, one or more laser pulses occurring within a processing period that is synchronized with the trajectory and a sequence of targets to be processed.

According to some aspects, a laser based system for processing target material on a substrate, the system including a laser source for generating one or more laser pulses occurring within each of a plurality of processing periods alignment means for aligning the laser beam at an intersection position of the laser beam axis and the substrate relative to one or more features of the substrate on or within the substrate, mechanical positioning means for moving the substrate along a processing trajectory relative to the aligned laser beam axis intersection position, solid-state beam deflection means for addressing positions within an addressable field by deflecting the intersection position of the laser beam axis, the field including an aligned intersection position, the addressable field having an area and dimension relative to the aligned intersection position, and control means for determining the processing trajectory and a sequence based on target material locations, mechanical positioning parameters, and addressable field parameters and for generating commands to move the substrate along the processing trajectory, to deflect the intersection position of the laser beam axis and the substrate to a position within the addressable field and offset from the trajectory, to impinge at the deflected intersection positions onto target material according to an offset dimension one or more laser pulses occurring within each of multiple processing periods synchronized with the trajectory and the sequence of targets to be processed.

According to some aspects, a method of processing material of device elements by laser interaction, the elements distributed at locations about a workpiece, the method including generating a pulsed laser processing output along a laser beam axis, the output comprising a plurality of laser pulses triggered sequentially at times determined by a pulse repetition rate; generating a trajectory relative to locations of device elements designated to be laser processed, said trajectory comprising a motion profile of an optical system axis intercept point at the workpiece; driving relative motion of the intercept point and the workpiece along the trajectory; predicting the position of one or more designated device elements relative to the intercept point position on the trajectory at one or more laser pulse times; deflecting the laser beam axis relative to the optical system axis to sequentially offset focused laser spots from the intercept point within a predetermined deflection range based on the predicted position; and irradiating the designated elements with pulses from the laser output at the offset laser spots, wherein the elements are conductive links of electronic devices, the workpiece is a semiconductor substrate and processing comprises severing designated links.

According to some aspects, a method for laser processing a multi-material device including a substrate and at least one target structure, the method including producing relative motion between a beam delivery subsystem and a substrate, the relative motion characterized by a processing velocity profile that includes a non-constant velocity motion segment; generating a pulsed laser output comprising a sequence of pulses, pulse groups, combined pulses, or pulse bursts, the sequence being generated at a substantially constant repetition rate during the motion segment; transmitting a control signal corresponding to a predetermined estimated target position and an estimated laser firing time associated with the target position; and deflecting the laser output with a high speed deflector responsive to the control signal to irradiate the target position at the laser firing time; whereby a pulse, a pulse group, a combined pulse, or a pulse burst generated at the laser firing time impinges the target to at least initiate processing during a non-constant velocity motion segment.

### BRIEF DESCRIPTION OF THE DRAWINGS

FIG. 1 is a block diagram illustrating several conventional components of a laser processing system.

FIG. 2 is a plan view of a row of links illustrating the application of laser pulses to selected links.

FIG. 3A is a block diagram illustrating system elements of a laser processing system according to some exemplary implementations.

FIG. 3B illustrates various exemplary implementations of a laser pulse.

FIG. 3C illustrates the operation of an acousto optic beam deflector (AOBD) according to some exemplary implementations.

FIG. 3D is a block diagram illustrating system elements of a laser processing system according to some exemplary implementations.

FIG. 4 illustrates a control architecture according to some exemplary implementations.

FIGS. 5A-5C illustrate AOBD beam steering compensation for two wavelengths.

FIG. 6A illustrates a filed size of a deflection field according to some exemplary implementations.

FIG. 6B illustrates a two-dimensional deflection according to some exemplary implementations.

FIG. 6C illustrates variable field size properties according to some exemplary implementations.

FIG. 7A illustrates a mechanical trajectory according to some exemplary implementations.

FIG. 7B illustrates a system of planned offsets according to some exemplary implementations.

FIG. 7C illustrates a virtual processing path according to some exemplary implementations.

FIG. 8 illustrates a trajectory planning method according to some exemplary implementations.

FIGS. 9A-9C illustrate an input signal and an RF and Acoustic response to the input according to some exemplary implementations.

FIGS. 10A-10B illustrate AOBD efficiency plots according to some exemplary implementations.

FIGS. 11A-11F illustrate two dimensional arrays according to some exemplary implementations.

FIGS. 12A-12C illustrate focusing on portions of a curved field according to some exemplary implementations.

FIGS. 13A-13D illustrate field shapes according to some exemplary implementations.

FIG. 14 illustrates a method of velocity optimization according to some exemplary implementations.

FIG. 15 illustrates a method of optimizing the number of blasts according to some exemplary implementations.

FIG. 16 illustrates a method of velocity optimizing according to some exemplary implementations.

FIGS. 17A-17C illustrate processing sequences according to some exemplary implementations.

FIGS. 18A-18E illustrate processing sequences according to some exemplary implementations.

FIG. 19 illustrates a timing diagram of a predictive processing method according to some exemplary implementations.

FIG. 20 illustrates a flowchart of a predictive processing method according to some exemplary implementations.

FIGS. 21A-21C illustrate a pulse stacking process according to some exemplary implementations.

FIG. 22 illustrates link processing on acceleration according to some exemplary implementations.

FIGS. 23A-23B illustrate a curvilinear link processing trajectory according to some exemplary implementations.

FIG. 24 illustrates a deflected beam axis according to some exemplary implementations.

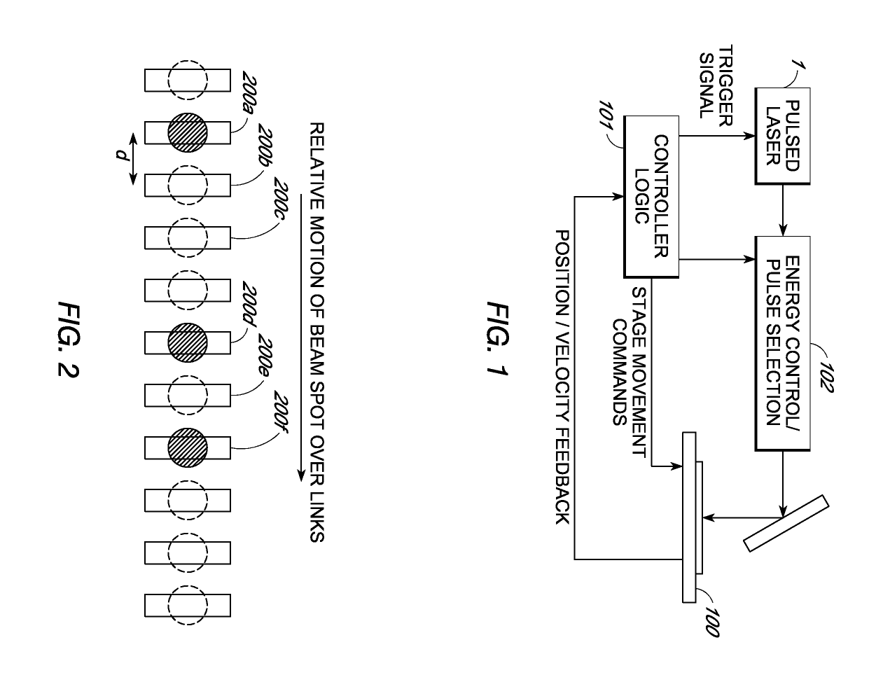

### DETAILED DESCRIPTION

### Overview

Multi-axis inertialess beam positioning is used to access processing targets relative to the trajectory of a mechanical positioning system to sever conductive links at high rates. Various laser processing aspects using split and/or deflected beams are disclosed in US patent publication 2009/0095722. This document is incorporated herein by reference and forms part of this application. The present disclosure is primarily directed to rapid access with a single beam. In particular, the approach uses high speed positioning within a two dimensional random access field that moves along a trajectory relative to the wafer. Positioning laser spots within the field at a processing rate allows flexible access to links passing through the field along the trajectory with a throughput exceeding a conventional link pitch based processing rate. Elapsed time traditionally required for passing over unprocessed links can be reduced, a higher percentage of laser pulses are used for processing, and processing throughput can be increased.

Generally, the position of each blast in this scheme is determined by a combination of mechanical stage position (the nominal spot position along the trajectory) and a spot displacement. A stage carrying a target substrate moves along a processing trajectory, and periodic laser blasts are fired along the trajectory to process selected targets on the substrate. For each selected target, a control unit determines the exact time of a corresponding laser blast. The control unit also computes a spot displacement relative to an aligned field position for the blast using the target coordinates and stage coordinates that correspond to the blast time. An inertialess beam deflector deflects the laser beam axis according to the spot displacement and the laser is commanded to fire at the specified time, so that the laser spot is positioned on the target when blast is issued.

In this way, efficient processing is unencumbered by traditional assumptions about target locations such as regular target spacing, row allocation, and target orientation. Moreover, stage velocity can be selected over a continuous range of values to optimize throughput without the traditional constraints of matching a laser pulse rate to a uniform link pitch and the attendant trade-offs. The present approach allows for higher stage velocities and provides considerable flexibility so that arbitrary link placement can be handled as well as traditionally structured layouts.

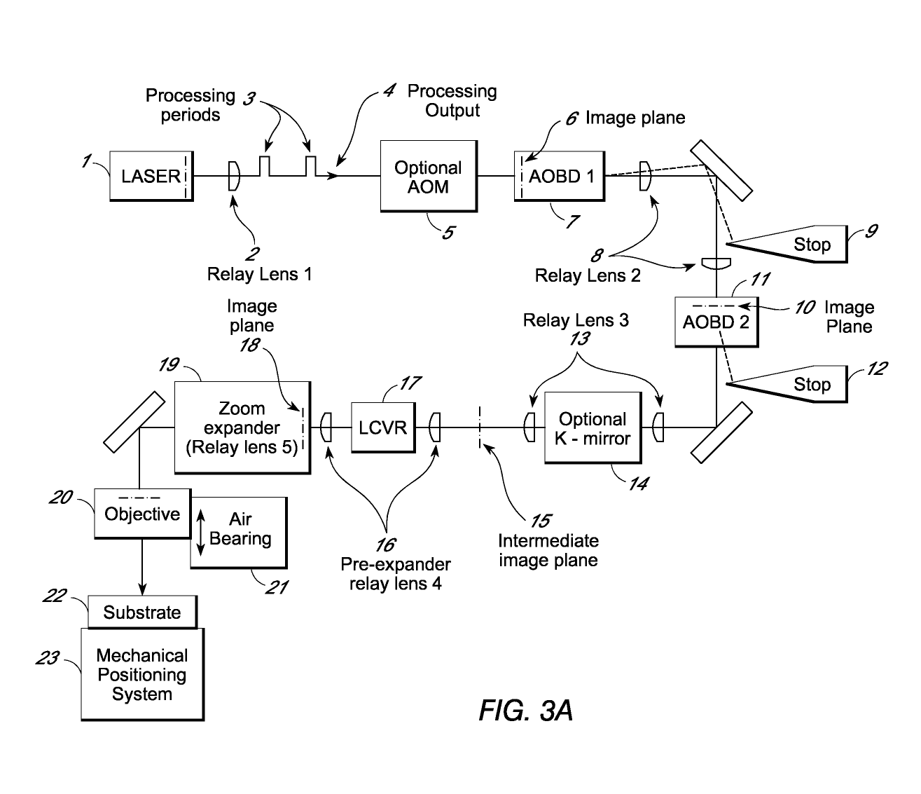

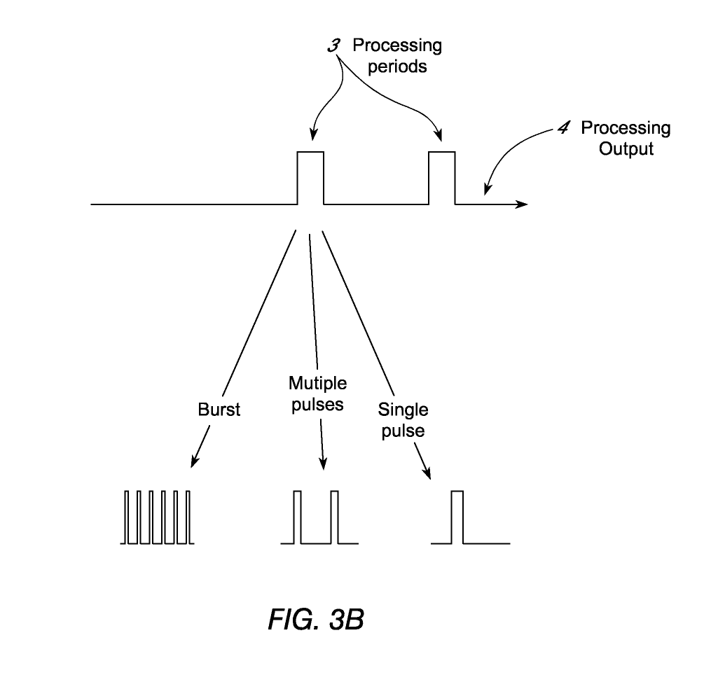

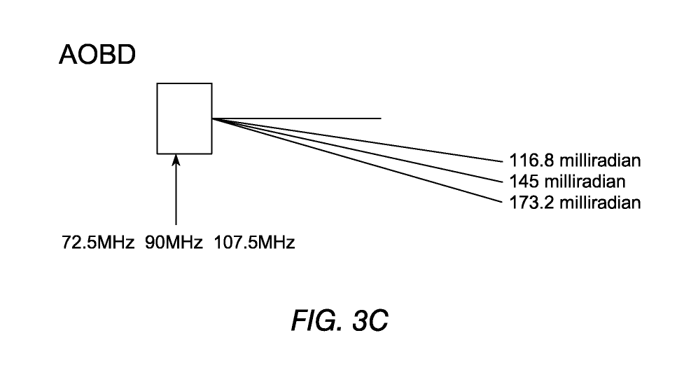

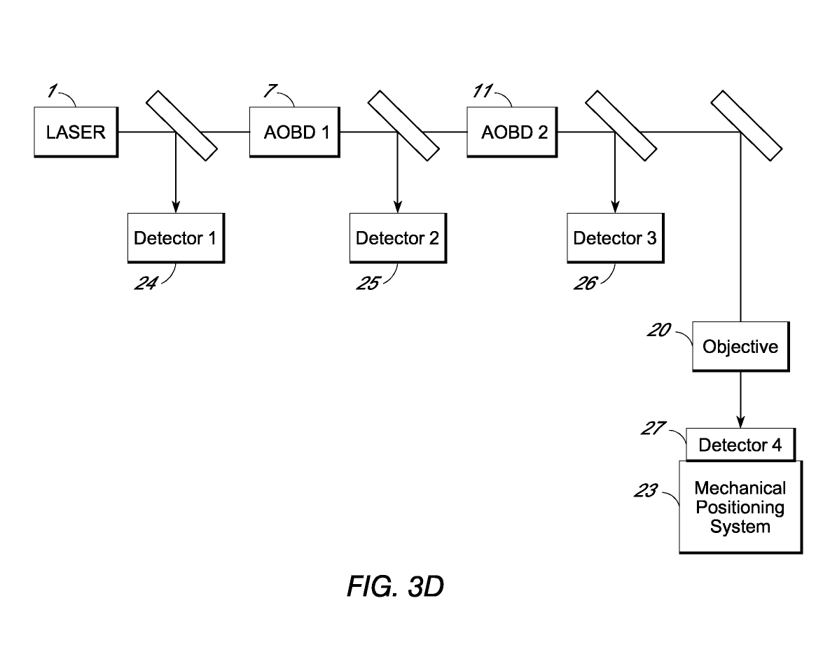

As shown in FIG. 3A, system elements comprising a multi-axis inertialess deflector based laser processing system for link severing include, among other elements, a laser source, multi-axis inertialess deflectors and associated drivers, relay optics, beam expanding optics, spot forming optics, and a mechanical positioning system. As shown in FIG. 3A, a laser 1 outputs a laser pulse through a first relay lens 2. The laser pulses may occur during processing periods 3. An acouto-optic modulator 5 (AOM) may receive the laser pulse at a processing output 4 for selectively blocking some of the output pulses. In at least some embodiments, this AOM 5 is an optional component in the system. A first beam deflector 7 (AOBD 1) may deflect the received laser pulse along a first axis as described further below. Relay optics may include relay lenses 8 and mirrors for reflecting the laser along the optical path of the system. The system of FIG. 3A includes a first stop 9 which prevents unwanted energy of the first deflector 7 from propagating into the second deflector 11 (AOBD 2). A second deflector 11 may deflect the laser beam along another axis as will be described further below. A second stop 12 may prevent unwanted energy from the second deflector 11 from proceeding along the beam path. The beam may proceed through relay optics as shown in FIG. 3A. The relay optics may include relay lenses 13, optional K-mirror 14, and relay lenses 16. Relay lenses 16 may be formed as pre-expander lenses. A Liquid Crystal Variable Retarder 17 may be used as a polarizing element as will be described below. The beam may proceed to a zoom expander 19. A mirror may deflect the beam to an objective lens 20. The objective lens may focus the beam on a substrate 22 mounted on a mechanical positioning system 23. One of ordinary skill in the art will recognize that other relay optics and lenses may be employed in order to focus the beam on the substrate 22, reduce aberration or astigmatism, and make the optical system more compact. The operation of the various components will be described in greater detail below.

In at least one embodiment, detectors may be included in the system illustrated in FIG. 3A. FIG. 3D illustrates one configuration of such a system according to some embodiments. A detector 25 may be situated after deflector 7 and before the deflector 11 as shown in FIG. 3D. The system may further include additional detectors 24, 26, and 27 before the deflector 7 and after deflector 11. Each detector detects laser pulse energy and/or average laser power. The detectors may be used to provide feedback to adjust the various components in the system especially as it relates to maintaining a desired pulse energy on the targets being processed.

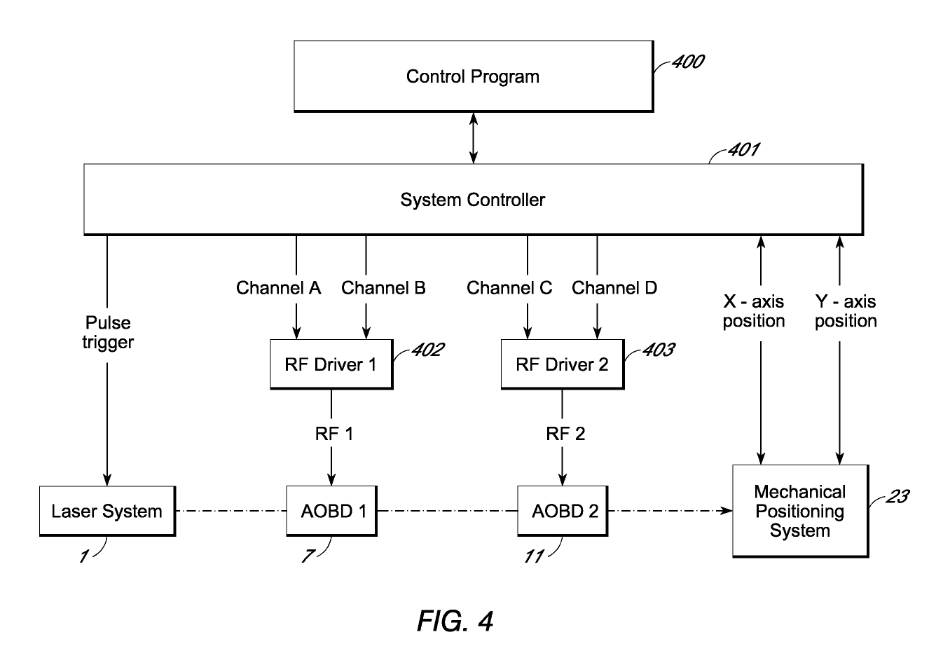

A system control architecture shown in FIG. 4 may include a system controller 401 and a control program 400 that coordinates mechanical motion, inertialess positioning and laser firing. As shown in FIG. 4, the system controller 401 may communicate with a first RF driver 402 and a second RF driver 403 through communication channels A-D. The RF drivers 402, 403 may drive the AOBD 1 (deflector 7) and the second AOBD 2 (deflector 11) respectively. The system controller 401 may also provide the pulse triggers to the laser system 1, and the X and Y positioning signals to mechanical positioning system 23.

Many aspects of this invention are largely independent of laser material interactions and processing energy windows for various regimes of lasers and pulse types. These aspects relate primarily to improved beam positioning and throughput, however to the extent that positioning accuracy is improved or new types of lasers or new modes of operation are used, some aspects may be process related. In general, beam positioning aspects of this invention, using high-speed positioning within in a two dimensional field moving along a trajectory, can apply to many different types of laser processing.

### Lasers

Laser source (1) generates a laser processing output (3). In at least one embodiment, the processing output includes processing periods 3 as shown in FIG. 3B preferably equal to or less than 14 microseconds, during which the laser outputs a single pulse, a shaped pulse, multiple pulses, closely spaced bursts of ultra short pulses or a combination of pulse types. Any type of laser with a pulsed output suitable for severing links may be used, for example q-switched, fiber amplified, and mode-locked lasers. For the purposes of this invention, Processing Repetition Frequency (PRF) will refer to the repetition rate of processing periods. Burst rate will refer the repetition rate of pulses or sub-pulses within a burst. Preferably the PRF meets or exceeds 70 kHz. The PRF may correspond directly to a laser pulse rate or may correspond to a down sampled output rate where a laser source pulses at a rate higher than the PRF. For example, for a 70 kHz q-switched laser the PRF is 70 kHz. For a double pulse laser with 2 pulses falling in the processing period, the PRF would remain 70 kHz. Likewise, for a sequence of bursts the PRF would correspond to the rate of bursts produced for processing regardless of the number of individual pulses in each burst. As described below, the maximum PRF may be limited by the minimum AOBD acoustic pulse width and the pulse stacking capability of the AOBD. Laser wavelength can be any known processing wavelengths, such as UV, visible and Infrared wavelengths and one skilled in the art would select suitable components in the optical path according to wavelength and beam properties. Preferably, the laser will have a narrow spectral line width of less than 1 nanometer to minimize dispersion effects. Generally the laser beam is a TEM00 Gaussian beam and beam path optics are selected to provide excellent spot uniformity. Various spatial beam modification techniques such as beam shaping and spot shaping can be used.

AO devices

### AOBD 1

Output from the laser source is directed along a beam path to the input aperture of a first acousto optic beam deflector AOBD 1 (deflector 7). As shown in FIG. 3C, AOBD 1 provides controllable beam deflection by Bragg diffraction responsive to a variable frequency RF diver signal and can split the beam when multiple frequencies are applied simultaneously. The deflected beam is generally a first order diffraction beam. The diffraction angle of diffracted beams varies with the RF frequency input, and as a result the diffraction angle is varied and the first order beam is controllably deflected. The beam path to AOBD 1 may include optical elements to modify the beam size and waist position to optimize AOBD 1 performance, for example the path may include a relay lens (2) to image the beam waist onto the AOBD aperture. The beam path to and/or from AOBD 1 or AOBD 2 will generally accommodate the first order center frequency deflection angle; the straight path shown in FIG. 3A is merely a schematic simplification. As is well-known, in some cases anamorphic optics can be employed to image onto an elliptical AOBD window to increase the number of possible imaged spots, and input polarization can be controlled to match AOBD requirements.

Acousto-optic beam deflectors may also be referred to as acousto-optic Bragg deflectors, acousto-optic deflectors (AOD), acousto-optic devices (AOD) or acousto-optic modulators (AOM). Any one of these terms applies to a Bragg regime deflector. AOBD and AOD are considered synonymous and generally refer to devices optimized for variable deflection. AOM usually refers to a Bragg cell that is optimized for high extinction and high efficiency as an amplitude modulator, however over small ranges with varied frequency input an AOM can provide variable beam deflection. The specific construction of the device in various configurations such as, off-axis designs, phased array, alternate materials etc. may be used as beam deflectors in this invention. Other types of acousto optic devices, for example variable filters, may also be considered as deflectors in some cases. It will be understood that any variable deflector operating in the Bragg regime is considered an AOBD for the purposes of this disclosure. Deflectors with similar or superior characteristics may be used in various aspects of this invention, for example deflectors that provide decreased access speed, increased time bandwidth product, improved efficiency, more addressable spots, or reduced beam distortion. Alternate deflectors may be improved AOBDs, electro-optic deflectors or any other type of high speed inertialess deflector.

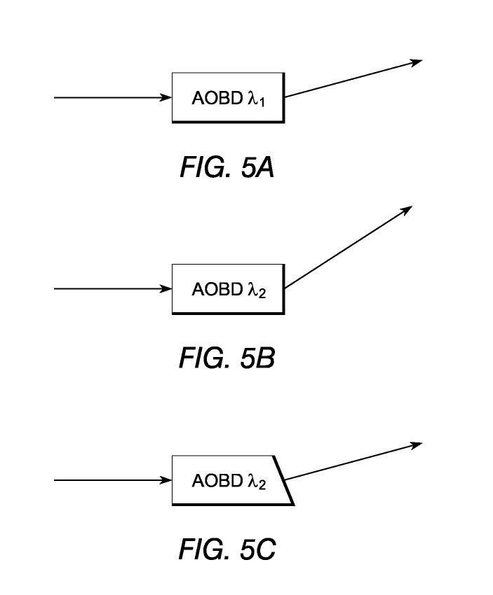

It will be appreciated that each AOBD is designed for a specific wavelength and that the center frequency will correspond to a different deflection angle for different laser wavelengths. In the case of an optical system designed for different wavelengths, accommodation may be required for differences in deflection angle when the laser source wavelength is changed. In at least some embodiments shown in FIGS. 5A-5C, an offsetting deflection is provided for one or more wavelengths so that the center frequency deflection angle can be matched for different frequencies. In this way, a common beam path can be used for different wavelength laser sources. The offset deflection is preferably introduced by adding a wedge angle to the Bragg cell crystal to best approximate identical pointing of different wavelength AOBDs. Correction could also be provided with optical wedge prisms or other means. By adding wedge to each AOBD for zero deflection at the center frequency, a simplified in line layout may be possible.

### RF Drivers

It will be appreciated that AOBDs are driven by specialized RF drives (102, 103) that are capable of supplying multiple frequencies to the active deflector cell. Considerations for the RF driver include thermal stability, frequency range, stability and resolution, output power range stability and resolution, number of simultaneous frequencies, frequency switching time, modulation bandwidth, dynamic range, intermodulation, and signal to noise ratio. Drivers may be available as suitable versions from AOBD manufactures or custom as electronic modules.

In a preferred arrangement, four amplified DDS channels (A, B, C, and D in FIG. 2), 2 per axis are provided to allow a combination of high resolution random access deflection in two dimensions with beam splitting capability in each axis. For beam splitting, 2 frequencies are combined and amplified per axis, each frequency corresponding to a laser spot position in the field. When splitting a beam into more than two beams per axis is required, additional channels are added for combination and amplification for each axis. A suitable driver multi-channel driver is the 8 channel driver from Crystal Technologies: CTI P/N 97-02861-10, AODR SYNTH DDS 8CH OEM2 STD, CTI P/N 24-00107-01, Driver Amplifier ZHL-2.

### AOBD 2

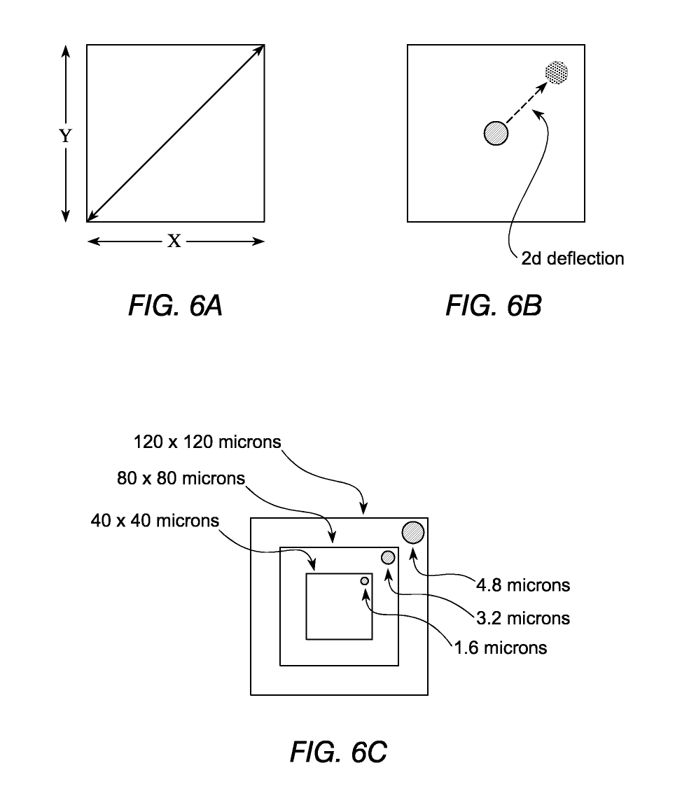

For two axis deflection, the AOBD 1 (7) may itself be a two axis device with multiple transducers on a single acousto-optic crystal or multiple AOBDs each with its own transducer or transducer array, such as AOBD 1 and AOBD 2 may be used to provide beam deflection in two axes as shown in FIGS. 6A and 6B, either in a closely stacked configuration or a spaced-apart configuration. In a preferred embodiment AOBD 2 (deflector 11) is spaced apart from AOBD 1 with intervening optics along the beam path to relay the image of the AOBD 1 to AOBD 2. The relay optics 8 may modify the beam diameter as needed to optimize performance of AOBD 2. Anamorphic optics may also be used in this relay stage to impinge AOBD 2 with an elliptical beam. Preferably, the layout provides rotation between first and second deflection axes to allow both deflectors to be mounted in the same preferred orientation. For example, the periscope arrangement of 2 folding mirrors can provide a 90 degree optical path fold and a 90 degree beam rotation. The first mirror folds a horizontal beam to vertical and the second mirror folds the vertical beam back to horizontal with a 90 degree fold with respect to the input horizontal beam. In this example, each AOBD can be mounted to deflect in a vertical plane where the beam rotation between deflectors allows for 2 axis deflection. Folding mirrors may also accommodate, among other things, the first order center frequency input and output angles. Inputs and outputs may deviate from the horizontal plane to match the input Bragg condition and provide an output generally centered with respect to the horizontal plane by adjusting the fold angle to direct the beam along a preferred axis. Other arrangements are possible.

### Knife-Edges

It is to be understood that each AOBD will generate a zero order, non-deflected beam in addition to the desired deflected beam. As a matter of routine design, the zero order beams are fully attenuated for example with a knife edge. The spaced-apart layout provides access for separate knife-edges such as beam stops 9 and 12 or each deflection axis and prevents unwanted energy from the zero order of the first AOBD from propagating into the second AOBD. Other types of beam attenuators are possible, for example in polarization active AOBDs, polarizers maybe used to attenuate zero order energy. In addition to zero order beams, other undesired higher or lower diffraction order beams may be present and may be attenuated in a conventional manner.

### LCVR

Following first and second AOBDs, beam conditioning optics may be employed in the beam path, for example polarization control optics such as a Liquid Crystal Variable Retarder 17 which may be used to adjust polarization according to target type or link orientation as described in U.S. Pat. No. 6,181,728. The beam path may include relay optics 13 to modify the deflected output beam for entrance to the LCVR, for example to fit a well collimated beam into a limited active aperture. These relay optics may further image the pupil of the second AOBD to an intermediate image plane 15 and may provide further anamorphic optics in an anamorphic beam path arrangement.

### Beam Expander

Following the first and second AOBDs and beam conditioning relay optics, the image of the deflector pupil is expanded. A pre-expander relay 16 may reimage the deflector pupil, for example the intermediate image 15 of the deflector pupil described above to the input pupil of the system beam expander 19. As described in the 20090095722 publication, a beam expander, preferably a zoom beam expander is used to image the deflector pupil or an image of the deflector pupil to the entrance pupil of the processing objective 20. Position of the zoom beam expander can be used to adjust the deflector pupil image location at the objective pupil to improve telecentricity, and might be adjusted to different axial positions to improve telecentricity of either deflection axis. Beam expander optical groups, for example 3 groups as described in 20090095722, may be driven in linear motion precisely using Nanomotion HR2 piezo drives and MicroE Mercury 2 encoders. As the beam expansion is changed the beam diameter at the objective lens changes, and hence the spot size in the field changes accordingly.

This process will be explained with reference to FIGS. 6A-6C. A field size as shown in FIG. 6A, may be characterized as having a width x and a length y such that the field size may be represented as a function of x and y. A beam may be have a two-dimensional deflection within the field as illustrated in FIG. 6B. In addition to changing the spot size, a beam expander changes the deflection angle in inverse proportion to a respective expanded beam diameter. As a consequence and as shown in FIG. 6C, when the beam is expanded and spot size is reduced, the deflection angle is reduced and the field size is reduced. For example, a beam having a 4.8 micron diameter may have a field size of 120×120 microns. A beam having a diameter of 3.2 microns may have a reduced field size of 80×80 microns. A beam having a diameter of 1.6 microns may correspond to a reduced field size of 40×40 microns. One of ordinary skill in the art will recognize that the spot size and corresponding field size is not limited to the above described examples.

The number of focused spots that can be addressed in the range of the deflector over the field will be constant regardless of the beam expander setting. So, there is a direct trade-off between spot size and field size with small spots over a small field and larger spot over a larger field. In conjunction with the processing lens, methods according to U.S. Pat. No. 7,402,774 can be used to provide a range of field sizes and spot sizes without degradation of the spot over the field.

### High Numerical Aperture Objective Lens

Preferably the processing lens 20 is a high numerical aperture objective lens of at least NA 0.7 to provide spots as small as 1.4 microns or 0.7 microns for the processing wavelengths 1064 nm and 532 nm respectively. The objective lens is preferably mounted on an air bearing, for example air bearing sled 21 and translated axially according z height positioning commands as described in U.S. Pat. No. 6,483,071. Preferably the lens will have a working distance of 6 mm or more to avoid contamination from processing debris and to provide mechanical clearance. The lens may be achromatized to provide spot formation with broadband fiber laser sources or for imaging with auxiliary through the lens viewing equipment. Preferably, the lens will have a field of view of at least +−20 microns with the smallest spot setting and largest input beam. Preferably the field of view will be at least +−80 microns for the largest spot setting. Most preferably, the field of view will be +−80 for small spots and +−500 micron for large spots. Preferably, the field will be a flat field with a field curvature less that 10% of the spot depth of focus. Field flatness may be for example 0.1 micron over +−20 microns.

Generally, the field of view of the lens is circular and the deflection field shape is addressed within the lens field of view. The deflection field accessed can be selected as the entire lens field of view, or any portion of the lens field of view. This may be a circular truncation of a superscribed square deflection field, an inscribed shape such as an inscribed square or a partially truncated deflection field. The deflection field when using AOBD positioning is limited by the maximum number of spots available from each deflector. In some cases, for example with small spot sizes, the addressable field may be smaller than the lens field of view.

### Mechanical Positioning System

The wafer substrate 22 with links to be processed is mounted on a wafer chuck for processing. The spot formed by the objective impinges the surface of the wafer. The chuck is carried on a stage or mechanical positioning system 23 according to any of the well-known mechanical positioning configurations. One such configuration is the 2 axis fine stage supported by an air bearing that travels over a 2 dimensional portion of a wafer as found in GSI Group model M550. For this type of system, full wafer coverage is accomplished by stepping a beam delivery system in increments over the wafer and sequentially processing small areas of the wafer with fine stage motion. Alternately, full travel single axis stages in stacked or split arrangements or other configurations and various combinations including galvanometer positioning as know in the art can be used as the mechanical positioning system. Regardless of the particular mechanical positioning configuration, the mechanical positioner moves the substrate relative to a nominal laser beam axis to provide mechanical positioning of targets in a processing trajectory.

Mechanical positioning may also include auxiliary mirror based deflection to provide improved dynamic performance. This has been implemented in the form of galvanometer based field scanning and more recently using a two axis fast scan mirror for stabilization. Yet another approach to improve dynamic performance of mechanical positioning is the use of force cancellation technology, for example as described in U.S. Pat. No. 6,144,118. With force cancellation, mechanical system perturbations and resultant mechanical positioning errors are minimized.

### System Controller

Coordination of laser pulsing, selective pulse picking for blasting selected links, spot displacements to access positions in the deflection field and mechanical stage motion is generally achieved using a system controller 401. The controller is used to generate laser trigger timing signals, pulse picking commands, spot displacement commands and stage positioning commands.

Preferably, the controller generates trigger timing signals that fire laser pulses at a substantially constant repetition rate either continuously or for a minimum interval prior to blasting to provide uniform pulse energy. Conventionally, the trigger timing signals often correspond to link positions on a regular pitch at a particular stage velocity. However, in the present invention, trigger timing signals merely correspond to a position along the mechanical trajectory that will be defined as a virtual link position. The virtual link position represents a position along the trajectory that would be blasted without a commanded displacement. However, with a displacement command, the blast is deflected to the desired blast location at the real link with an offset from the virtual link location. With a constant PRF and a constant velocity along the trajectory, the virtual link locations can generally be regarded as conventional links aligned in along a row on a regular pitch with typical laser timing requirements.

Laser triggering may be initiated by a comparison of the current position of the laser beam axis relative to a target coordinate so that when the position of the laser beam and a virtual link position coincide, accounting for a known lag in the firing sequence, the laser is triggered and the blast is fired to process the target link at the displaced offset position. Alternately, blast times can be scheduled in advance to coincide with virtual link positions according to a planned trajectory and associated blast displacements.

Processing blasts are fired by gating the triggered laser pulses according to pulse picking commands with an optical device (such as AOM 5 of FIG. 3A) to pass working pulses along the optical path to the target and pick-off any unused laser pulses. In some cases the optical device, for example an acousto-optic device, is also used to attenuate pulse energy. Preferably, the optical device is an AOBD that is used for both deflection and attenuation. However, to the extent that pulse equalization methods are employed to provide consistent pulse energy, irregular pulse timing may be possible. It will be appreciated that with certain types of lasers, pulses may be free-running or down sampled and that pulse triggering may correspond to selecting pulses from a sequence of available pulses. A system utilizing this type of laser is further described in U.S. Patent Publication 2008/0029491, the contents of which are incorporated herein by reference in their entirety. In some lasers capable of stable pulse on demand operation, pulse picking may not be required.

The system controller 401 also controls blast displacement relative to the trajectory and provides offset commands and deflection signals to position blasts within the AOBD field. With the use of a deflection field, the controller may generate commands that result from a combination of both time and position processing domains. Displacement can be calculated based on set blast times, blast time can be set based on set displacements, for example if only a limited set of deflections is available, or both blast time and displacement can be set in combination. As a result of the flexibility of this approach, blasts may be fired without either regular target spacing or regular pulse spacing.

Stage positioning commands control the stage motion and position the targets with high precision along the trajectory. Position errors measured or characterized during the trajectory can be accommodated in different ways. For example, errors in either axis can be corrected with corresponding adjustments within the beam deflection field by the AOBDs. When the instant blast position is known to a high accuracy, this method of correction can be used in both constant and non-constant velocity processing. For errors in the direction of mechanical motion, small changes in the timing of scheduled blasts can also be used to correct blast position.

### Control Program

System operation is managed by a control program 400 that executes process steps and issues control signals. The program may require operator input or may run automatically to process single substrates or batches of substrates. The program may reside in a storage medium integrated with the system, may reside in a removable medium or may reside at a remote location for downloading of one or more steps to the system. The control program executes processing steps that result in laser processing of unrepaired memory devices to sever selected conductive links and thereby increase the yield of functional memory devices on one or more semiconductor substrates.

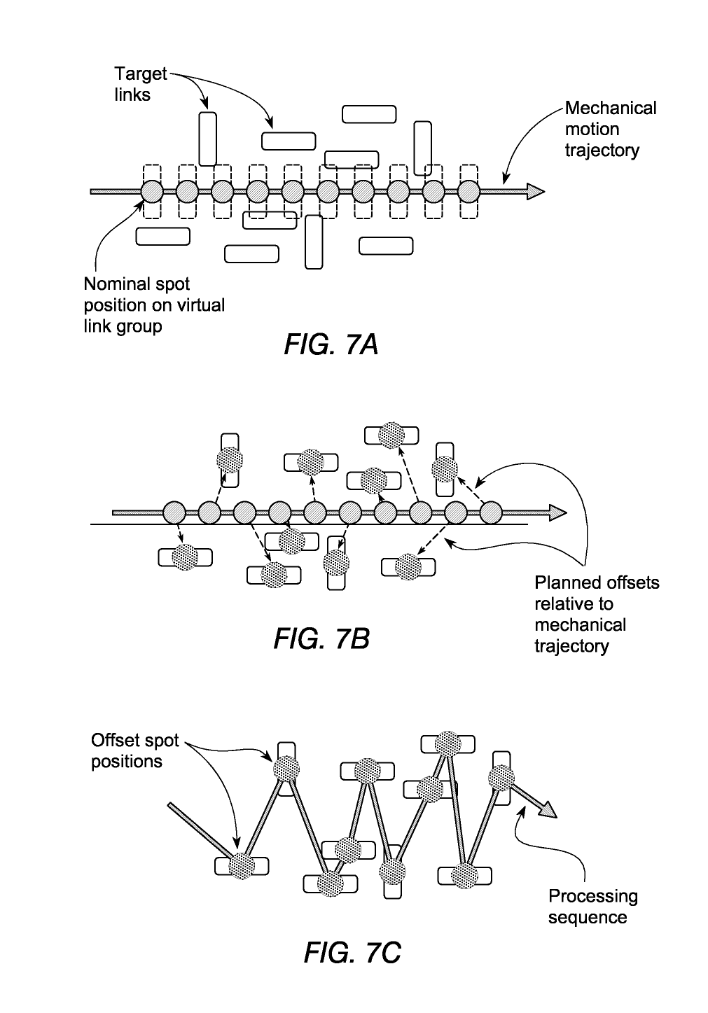

In at least one embodiment, processing occurs along a processing trajectory using a sequence of trajectory segments that position the virtual link positions, rather than the real link positions, relative to an aligned beam position. As shown in FIG. 7A, closely spaced, non-collinear links, can be considered a virtual link group in the mechanical positioning trajectory. Referring to FIG. 7B, a virtual link group along the trajectory is mapped to a group of links laterally displaced relative to the trajectory. Using this mapping, available blasts from the laser process each link in the virtual group by deflecting each assigned blast to the corresponding offset link. Mechanical positioning and laser firing proceeds along the trajectory, and the inertialess deflection field is addressed to direct each blast to the corresponding real link target location at the scheduled blast time. Since the laterally spaced ‘real’ links are not required to be located along the processing trajectory, rather within the addressable field at the blast time, the positional difference between the real link position at blast time and the virtual link position along the trajectory of moving substrate is accommodated with the inertialess deflectors. Considering that the inertialess deflector field is a two dimensional field, it will be appreciated that considerable flexibility in sequencing of links for processing is provided. FIG. 7C shows a virtual trajectory that superimposes the mechanical trajectory and the deflected offsets. The new mechanical trajectory plus inertialess offset processing regime extends the capabilities of current mechanical positioners without adding servo complexity.

Field access in the inertialess deflector field can include a general position offset that can be any combination of position either along or across the processing trajectory direction. With the capability to offset pulses along the processing direction, correction for measured position errors is an inherent feature. For scheduled blasts, adjustments to laser firing time are not strictly required. However, in some cases timing correction may be used to closely match current processing methods, or may be used in conjunction with inertialess access based error corrections.

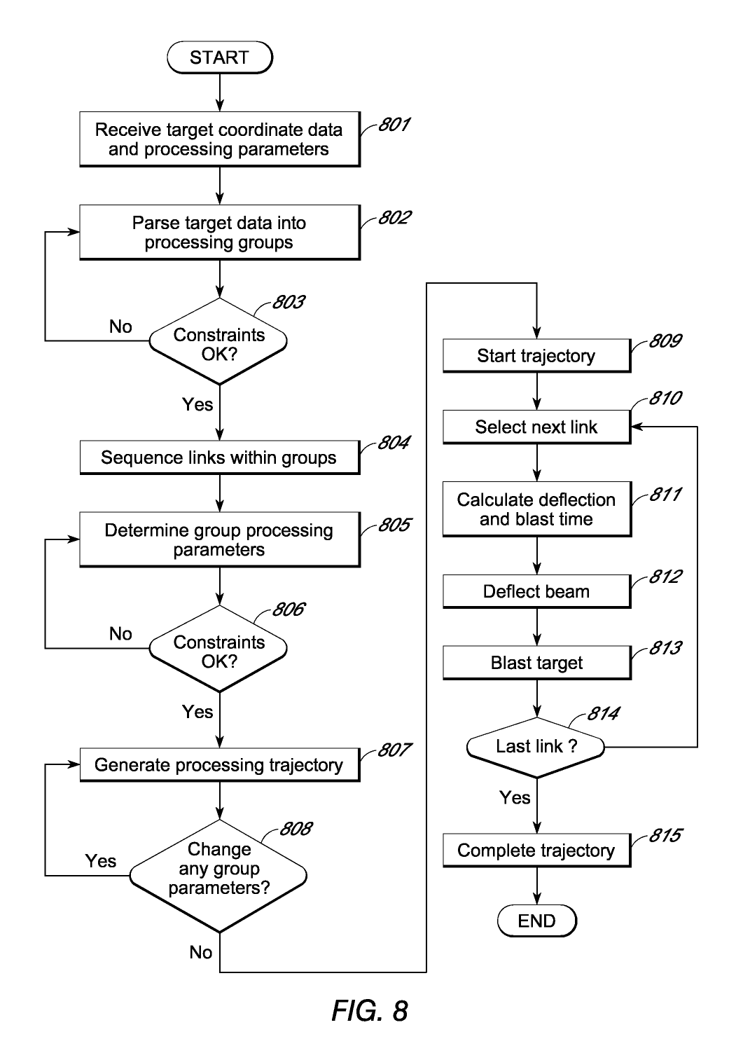

In at least one embodiment, referring to FIG. 8, the control program receives target coordinate data and processing parameters at block 801. The targets are parsed into processing groups at block 802, each group associated with one or more trajectory segments, at least one segment comprising a trajectory segment for mechanically positioning an addressable field relative or one or more targets. At decision block 803, system constraints are evaluated and targets are regrouped as required to satisfy the constraints. The targets in each group are then sequenced and, based on the sequence; group processing parameters are determined to satisfy system constraints at blocks 805 and 806. A processing trajectory including all groups is generated. Optionally, group parameters may be further evaluated at decision block 808 and the trajectory generation may be repeated for further optimization as illustrated by block 809. At block 810, mechanical motion is initiated according to the trajectory and a first target is selected for the sequence of targets to be processed. A blast time and a deflection is calculated for the target position at block 811, the deflection comprising the offset or the difference in position of the target and a blast position along the trajectory at the blast time. As illustrated by blocks 812-813, the beam axis is deflected according to the offset and the target is blasted at the blast time in the processing sequence. Subsequent targets are selected for blasting according to the processing sequence until the last target is processed as illustrated by decision block 814 and block 815.

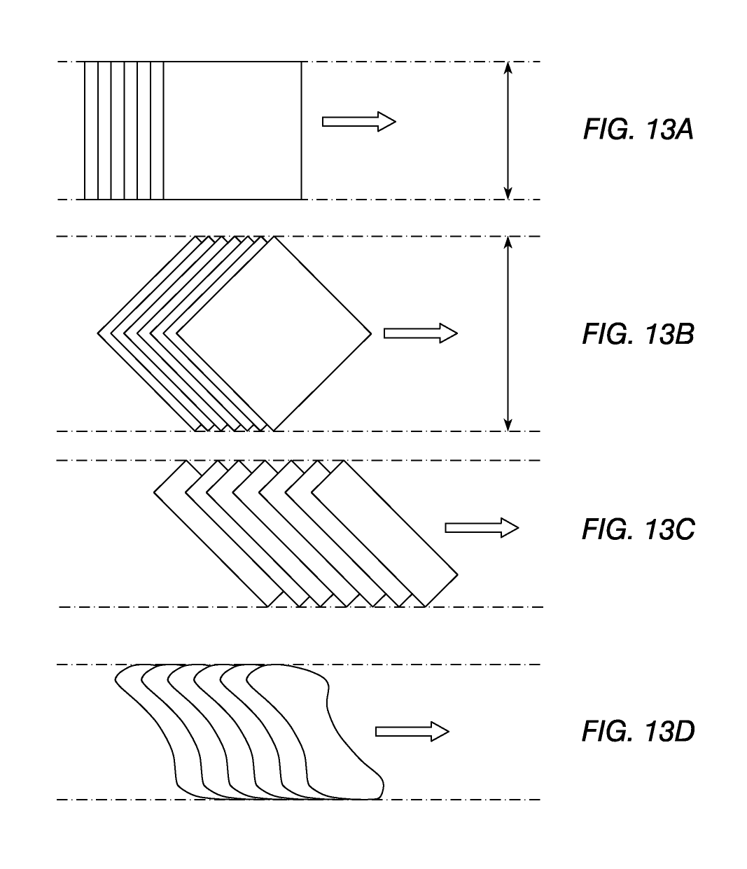

Generally, with current device layouts, links are formed in rows running thought the central axes of a die. Different local geometries may be used for example as shown in FIGS. 13-17 of published application 20090095722 show multiple rows and various staggered arrangements of links. Processing parameters and sequencing algorithms may be predetermined by the general type of layout or may be determined by an initial sequencing of a first device in a group of similar devices for use in subsequent devices or by a first set of link groups within a device for use throughout the device.

### Optimization Techniques

### AOBD Devices

Various optimizations known in the field of acousto-optic deflecting can be applied to the design and selection of the AOBDs used in various embodiments of the present invention. In at least one embodiment using a 1064 nm laser source, the AOBD selected is Crystal technologies model AODF 4090 1064 nm with a Te02 crystal, 90 MHz center frequency, 35 MHz bandwidth is used operating from 72.5 MHz to 107.5 MHz to generates 116 milliradian to 173.2 milliradian of beam deflection prior to beam expansion. For use at 532 nm AODF 4110 may be used. Preferably the 532 nm deflector is modified so that the beam entrance and exit are the same as for the 1064 nm version by adding a wedge so it fits easily into the optical path without major redesign and a common optical platform can be configured to operate at multiple wavelengths. Other vendors for AOBD devices include NEOS, Isomet and Sciner, and the devices may include alternate crystal materials and different constructions such as longitudinal mode, shear mode, and phased array devices among know AOBD device configurations.

Generally, an approach using spherical optics and round beams is preferred when a limited number of spots provide an adequate field of view and rapid access time is desired. For example, a 40 micron wide field including twenty-five 1.6 micron diameter spots maybe generated with the Te02 device described above. For wider field systems, an anamorphic beam path can be used with an increased acoustic window dimension along the deflection axis. Generally this will increase in the number of spots that can be addressed, roughly proportional to the increased size of the in acoustic window and with a corresponding increase the access time required to fill the longer acoustic window of the AOBD. With Te02, the shear mode acoustic velocity is 0.656 mm/us, so an increase of 10 mm to the acoustic window would add about 15 microseconds to the access time. Increased access time will in effect reduce the maximum PRF. This effect is a result of the so called time-bandwidth product of the AOBD.

Application 20090095722 among other art describes some routine aspects of AO design and optimization. Embodiments include the use of various AOBD types including on axis and off axis configurations. The AOBDs may be used to generate simultaneous spots, to generate rapid changes in spot shaping, to split a beam into various configurations having multiple spots along and across a row of links.

### Stacked Deflector Layout

As discussed, a simple arrangement of stacked AOBDs can be used to provide two axis deflections. This configuration has the advantage of a short optical path length and a limited number of optical components. Disadvantages include beam spreading across the acoustic window of the second device due to the deflection range of the first upstream device. The deflection point is different for each axis which can affect telecentricity at the target surface. Compensation can be provided by adjusting the image location of each deflector with relay optics as described in the 20090095722 publication.

### Relay Spaced Deflectors

Preferably, deflectors are spaced apart with relay optics. In this arrangement, the window of the first AOBD is imaged on to the second AOBD. Advantages of this arrangement include the ability to pick-off the zero order beam from the first AOBD before the second AOBD, the elimination of beam spreading across the second deflector window and maintenance of a single deflection origin point and for telecentric spot imaging in the processing field.

### Preferred Multiple Relay System

In a preferred embodiment, from the laser output aperture to the processing field, a total of five relays are used. The laser output is imaged to the first AOBD with a first relay lens. Next the first AOBD is imaged to the second AOBD with a second relay which may be for example a pair of lenses spaced according to focal lengths (i.e. a 4 f relay) to achieve a 1× magnification. The second AOBD is imaged with a third relay, which also may be a spaced lens pair, to an intermediate image plane. An optional beam rotor may be located in the optical path of this relay. The intermediate AOBD image is imaged to the input of the zoom telescope relay with a fourth pre-expander relay that may be a spaced lens pair arranged with a magnification to fill the entrance pupil of the zoom beam expander relay. The LCVR aperture may be located in a collimated region of the optical path of the fourth relay. Finally, the zoom telescope relays the input pupil with variable magnification to the objective lens. Thus, the laser beam waist is imaged to AOBD 1, and AOBD 1 is imaged successively to AOBD 2, an intermediate image plane, the entrance pupil of the zoom beam expander and the objective lens in a manner that accommodates an optional beam rotator and a polarization controlling LCVR.

Conveniently, one turning mirror may be located at the intermediate image plane following the second AOBD (not shown) to provide field adjustment without translation. In this case the turning mirror is in the image of each deflector to provide alignment by way of a field angle offset without translating the pupil image.

### Typical Performance Parameters

In operation multiple relay deflection and imaging system may be characterized by the following typical performance parameters:

telecentricity <0.05 radians
efficiency >70%
extinction >30 db
0.1 micron flatness over +−20 microns
Wavefront error per deflector 0.015 waves rms
Optical switching speed 1.5 us rise time, 2 us delay

### Dispersion Effects

AOBD deflectors are diffraction based devices, and the deflection angle is linearly related to the ratio of the grating period in the Bragg cell to the wavelength of the processing beam. If the wavelength of the light entering the deflector is changed, the deflection angle exiting the deflector changes proportionally. As noted in publication 20090095722 and U.S. Pat. No. 7,466,466, diffraction effects can have undesirable effects that can affect the performance of a laser processing system.

Some lasers have very narrow emission spectra, which means very little spread in the deflected beam due to dispersion. However, some lasers, such as fiber lasers may have spectra that are more than an order of magnitude greater than rod based lasers, for example. When used in an AOBD, an increased spectral bandwidth in a laser source can result in undesirable spreading in the spot image and result in an out of round spot shape. In addition, chromatic focusing can further degrade imaged spot quality.

As described in US Patent Publication 20090095722, pre-dispersion gratings and prisms can be used to offset lateral effects of broad band laser sources. Preferably however, laser sources will have sufficiently narrow line widths to avoid spot shape and focus distortion. Advances in fiber lasers have resulted in fiber lasers with line widths narrowed for efficient conversion by way of frequency doubling, for example lasers described in US Patent Publication 20090016388. This type of fiber laser can be used to preserve the advantages of a fiber laser source including temporal pulse shaping capability, while at the same time providing minimal dispersion and defocus artifacts in an AOBD based system.

### Acoustic Window Set-Up

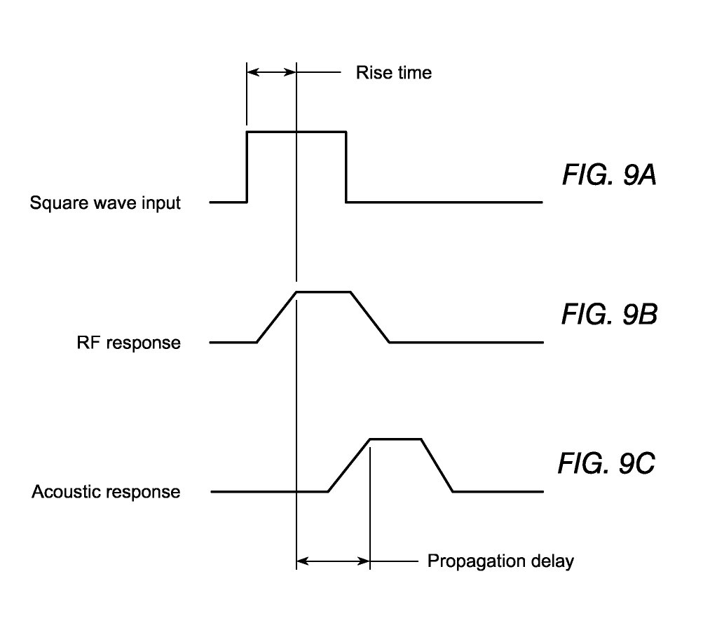

One aspect of AOBD optimization is the speed at which different position commands can be realized in a deflector according to the RF frequency applied to the AO crystal. FIGS. 9A-C depict signal envelope shapes of an applied command signal, an RF response and an acoustic response. The design of the AO crystal, the transducer geometry and the active acoustic window area generated will take into account many factors, such as efficiency, range of deflection, and intermodulation. Any type of suitable crystal/transducer geometry may be selected and used in an AOBD device. Preferably, a TEO2 crystal is used, although other types of Acousto-optic material, especially those developed for use in acousto-optic beam deflectors, may be used. Each device type, depending on the materials and construction geometry, as well as the geometry of the beam filling the acoustic window, will have a characteristic time it will take to setup deflection as the acoustic wave traverses the cell. Optimization may include measuring deflection efficiency versus time following a commanded deflection angle, determining the minimum lead time required to reach a desired efficiency at the deflection angle, and based on the time required to reach the desired efficiency, timing a laser firing sequence to fire a laser pulse at a minimum lead time to optimize a laser processing sequence. This optimization may take into account a different set of initial conditions, for example, the deflection state of the AOBD immediately prior to set up of a new deflection angle. Likewise, other AOBD performance characteristics may be analyzed and optimized to ensure a desired level of performance in a minimum set-up time.

Another related aspect of AOBD optimization in random access positioning is the duration of an applied RF defection signal. Duration of the applied RF, using the optimized lead time, can be varied while deflection efficiency or other parameters are measured. In this way a minimum RF deflection period can be determined for any particular AOBD device. The minimum RF period in conjunction with the minimum lead time can be used to further optimize a laser processing sequence.

### Stage Characteristics

In a laser processing system the stage performance can be limited by many constraints such as maximum velocity, edge of travel, and thermal loading. Acceleration and the resulting g-force applied to moving substrates may be limited by coil current constraints or by dynamic considerations. Generally, for high-speed positioning, the stage is light weight and dynamically stiff to maintain high precision without substantial mechanical deflection. Relaxation of constraints can be achieved in part by considering aspects of precision machine design. For example applying forces along the center of gravity to avoid induced deflection and optimizing machine geometry to minimize Abbe errors. In general, while need for high speed positioning persists even with use of inertialess deflectors, the length of mechanical trajectory and therefore its duration may decrease significantly when several trajectory segments are “merged” together by processing their corresponding links in a single run.

Management of constrains and resulting stage performance can enjoy benefits of an inertialess deflection field. With deflectors and an objective with an appreciable field or view, the field of view can be used at the edge of the stage travel to access edge positions while the stage is offset from the edge. This may allow for modification in management of edge link groups, associated trajectory segments and motion parameters. For example, velocity can be arbitrarily slowed rather than incrementally slowed, especially near the stage edge, while maintaining a constant PRF. High velocity can be used on links that might otherwise be too close to the edge of field. In some cases the addressable field of the stage can be increased by the field of view of the objective. For example a 50 mm stage field with a 1 mm deflector field would be able to address a 51 mm square target area. Conversely, stage field can reduced while accessing the full field with the deflectors, for example a 49 mm stage field with a 1 mm deflector field could address links over a 50 mm square area.

Adjustment of the mechanical field and accessible field can have profound effects to enhance throughput. In one example, marginal links may barely miss fitting into a processing field. Considering the tiling of the entire wafer into rows and columns of processing sites, the ability to increase the processing field even if only buy 100 microns, may allow a row and/or column to be eliminated from the wafer processing cycle removing the associated overhead of one or more processing sites, which is significant. Additional mechanical margin around a stage positioning field can allow more aggressive high speed positioning.

### Periodic Calibration

Generally, system calibrations with be performed on a periodic basis with certain calibration supplied at the factory, at system installation, at system turn-on, at wafer loading, for each processing site or during a processing sequence. Longer calibration periods are generally desired and may be associated with systems having increased stability, performance and reliability.

### Alignment

Generally, system alignment will include conventional alignment techniques such as edge scanning of reflective alignment targets to achieve overall system positioning accuracies to 150 nanometers or less. A nominal AOBD field position such as the center frequency position can be used for the alignment routine. Of course, other positions may be used, for example field positions that are relatively low drift locations in the field. Multiple positions can also be used to add data redundancy or to include field calibration capability. As described in 20090095722, acousto-optic deflectors can be used in conjunction with target alignment scanning. For example, multiple points of an alignment feature edge within an inertialess deflection field can be sampled and averaged. Utilizing the extremely high bandwidth of AOBD, iterative edge scanning can be performed at high rates. Various combinations of stage motion and AO field scanning are possible.

Within the AOBD field, alignment targets may be L-shaped, square or other shapes can be scanned in both x and y axes without additional mechanical positioning steps. Alignment targets can be scanned on-the-fly during processing trajectory when they fall near link groups and can be traversed within the AO field as the field passes the alignment target.

In typical alignment scanning, first the alignment target is found to low precision with a pre-scan. Once the alignment target is located, high precision scanning over relatively short scan lengths is possible. With an appreciable AO deflection field, the pre-scanning process scan be achieved on-the-fly while the stage approaches the alignment target area, perhaps during a deceleration segment. On-the-fly pre-scanning can potentially eliminate associated overhead.

Mechanical positioning can be slowed or stopped for alignment with AO target scanning. This is especially attractive while scanning targets to determine focus characteristics in the z axis. While stationary, vibrations are reduced, thermal loading is minimal, and dynamic errors are eliminated. It is recognized that with high speed target scanning for focus, increased bandwidth in z positioning is attractive, for example, using axial piezo positioners to move the objective lens over a small range.

### AOBD Field Calibration

Routine field calibration may include calibration of static errors and slowly drifting errors by measuring fiducial positions in sufficient quantity spatially and temporally to determine correction values that can be applied to positioning commands in order to maintain positioning accuracy within a predetermined tolerance range during a processing operation. A typical tolerance range would be less than 10% of the size of target feature such as the width of a conductive link and less than half of the overall system accuracy. Preferably, the tolerance contributes only a minor fraction of the overall tolerance budget, for example 25 nanometers or less. Well-known techniques such as correction table generation and polynomial fitting can be applied. Recalibration periods can be determined with a combination of theoretical models and conventional system accuracy diagnostic routines. Calibration data may be generated during alignment scanning. For example, an AOBD field dimension may be calibrated by scanning multiple edges with a known separation or a single edge at different mechanical positions.

### AOBD Field Scale

Acousto optic field scale may be determined theoretically based on a range of applied RF frequencies applied, may be measured in the beam path as a deflection angle or beam position, or in the processing field with field calibration features. Deflectors may be calibrated independently or preferably in combination in a 2 dimensional field.

### AOBD Skew

Skew of a deflector relative to inertialess beam positioning coordinates can be adjusted by mechanical rotation of the deflector or rotation of one of more beam rotators. However, generally calibration of a 2 dimensional field will accommodate small residual skew errors resulting from mechanical mounting tolerances.

### AOBD Linearity

Generally, inherent linearity of AOBD deflections over small ranges of 10 to 100 spots across the field provides sufficient accuracy. However for improved accuracy, especially when a large number of spots across the field are used, linearity correction can be applied, for example using a correction table to transform real field positions to error corrected positions.

1d Energy Calibration

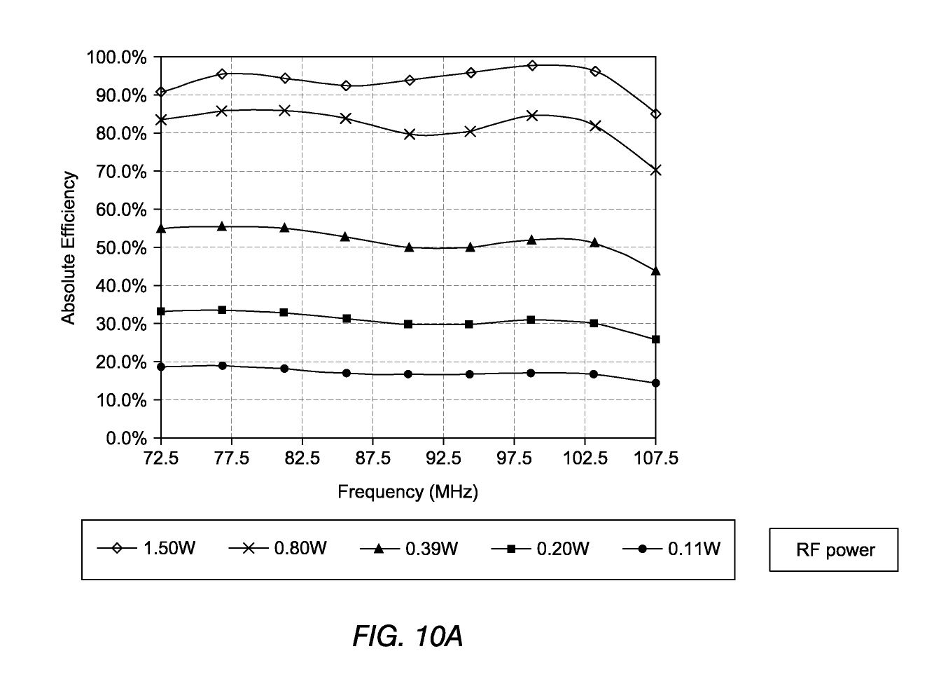

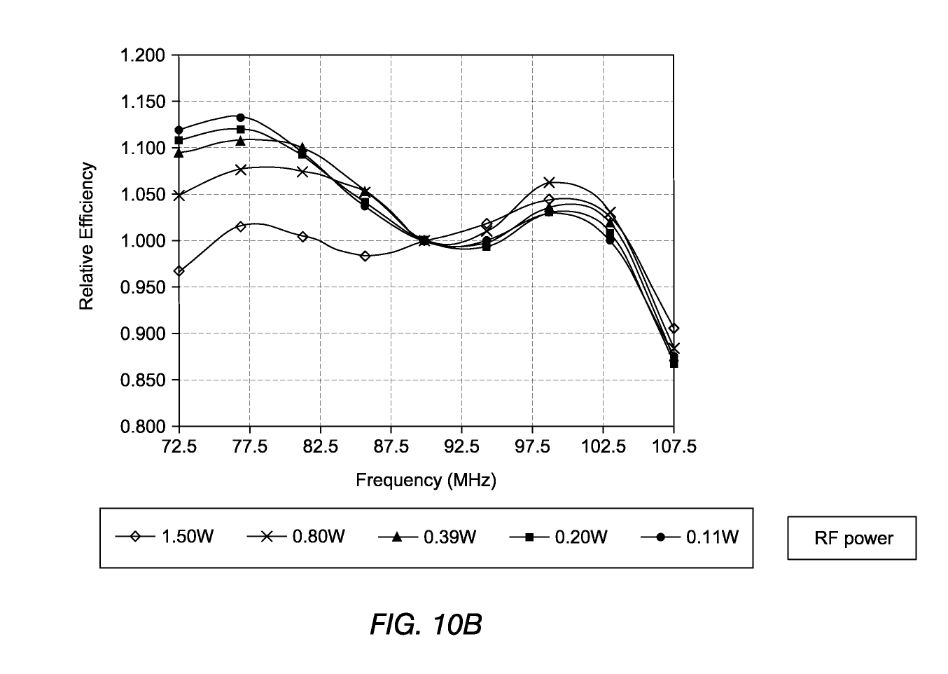

Compensation for variations of AOBD efficiency (AOBD efficiency is the ratio of pulse energy exiting the AOBD to the pulse energy entering the AOBD) by adjusting RF input power levels with field position is a well-known technique. Theoretical models can be used to predict efficiency performance versus angle and generate correction values; however each AOBD can have varying efficiency characteristics. As a result, efficiency characteristics, as shown in FIGS. 10A-10B are preferably determined by direct measurement of the deflected optical power. For correction, RF power can then be modulated according to the measured efficiency versus angle to maintain a uniform optical output across the deflection range.

However, AOBD efficiency versus angle also depends on the RF power level, so simple efficiency measurement at a static RF power level may be inadequate to accommodate this non-linear efficiency characteristic. Therefore, a more sophisticated correction scheme is needed. Dynamic measurements can be made by adjusting the RF level to match measured values to an efficiency target value over a range of selected deflection angles to generate an RF power versus deflection angle correction function for the efficiency target value. Alternatively, iterative measurements can be made across the deflection range for a nominal efficiency target value, starting with an initial RF correction function, determining residual efficiency errors versus angle based on efficiency measurements in subsequent steps, and generating an improved RF correction function using the residual error values. Other procedures may be used to accurately calibrate efficiency versus field angle such as generating an efficiency look-up table over the desired deflection and efficiency range. However, techniques that minimize data management overhead, such as determining sets of characteristic curves are preferred, especially when considering complexities of 2 axis deflection described below.

Modulating the RF power in an AOBD can be used to control optical attenuation. However since the efficiency curves change for different attenuations as shown in FIGS. 10A-10B, a set corrections curves is needed for different efficiency target values, each target value corresponding to a desired optical attenuation. These correction curves may be determined from direct measurements as discussed, they may be constructed from a characteristic data set or table, or the may be at least partially generated by interpolating values from 2 or more correction curves. This set of curves represents is in effect, a surface of RF power values required to calibrate an AOBD over the dimensions of deflection angle and attenuation level.

### 2d Energy Calibration

For 2 axis AOBD deflection using a pair of deflectors, calibration is required in each deflection axis. The efficiency of the second AOBD is dependent both on its own deflection angle and the angle of the beam entering from the first deflector, so it needs calibration over the additional variable of input angle. The dependence of calibration at different attenuation values applied in either AOBD makes the task of simultaneous deflection and attenuation with an AOBD pair complex. Attenuation can be applied in the first AOBD, the second AOBD or both AOBDs and the ability to effectively provide calibrated attenuation across the two dimensional deflection field is an important consideration. In a preferred calibration routine, the first AOBD is calibrated in the dimensions of deflection angle and optical attenuation value, and the second AOBD is calibrated at a single efficiency target value versus the variable input angle and output deflection angle. Calibration of the second AOBD is not dependent on optical energy of the beam, so attenuation can be provided in the first AOBD without compromising either calibration of the second deflector or calibration over the 2D field. In this case each AOBD is calibrated over two variables and the data intensive burden of calibrating the second AOBD over three variables is avoided. Of course an additional AOM can be used to provide variable optical attenuation and further relax the calibration requirements of the AOBD deflectors.

In at least one embodiment, a detector 25 may be situated after the first AOBD (deflector 7) and before the second AOBD (deflector 11) as shown in FIG. 3D. The system may further include additional detectors 24, 26, and 27 before the deflector 7 and after the deflector 11. Each detector detects laser pulse energy and/or average laser power. The single detector, or combinations of detectors when multiple detectors are used, may independently calibrate non-linear transmission in deflector 7 by measuring energy before deflector 11. The system may include means to evaluate the difference in pulse energy or average power between pairs of detectors. In conjunction with a detector preceding deflector 7, the first and second AOBDs, deflectors 7 and 11, can be calibrated independently from laser power drift or other upstream factors. The difference in power exiting deflector 11 and deflector 7 may be determined with multiple detectors. This provides a means for evaluating and calibrating the non-linear transmission of deflector 11 independently from deflector 7.

### Beam Splitting

In addition to providing beam deflection and attenuation, the AOBD can split the laser beam using 2 or more frequencies simultaneously in the acousto-optic crystal to deflect portions of the input to multiple angles. When beam splitting is used to generate multiple simultaneous spots, energy calibration is further complicated. Not only does the calibration need to account for two axis deflection and attenuation in multiple AOBDs, the calibration must also account for the balance or prescribed split of energy and the separation angle between split beams in at least one axis. When possible, single beam positioning is preferred, however aspects of beam splitting may be advantageous in certain circumstances to achieve high throughput rates.

One method used to measure pulse energy for the above calibration methods and other system routines includes use of an energy detector such as an in field integrating sphere and photodiode, for example detector 4 (27) shown in FIG. 3D. This type of detector can measure single spot energy and the combined energy of multiple closely spaced spots. However, measuring individual spots from a group of multiple split spots is difficult when spots are closely spaced, for example spaced on the order of several to 10's of microns. In this case a pick-off at or near the spot image plane is required, which is difficult to achieve at this scale. However calibration for split-beam processing requires energy measurement of at least one, and preferably all split beams. Considering that efficiency calibration in AOBDs is dependent on the RF level applied, it is desirable to operate the AOBD at operating RF levels for direct energy measurement and calibration while splitting the beam.

In at least one embodiment, reflected energy is measured from various targets at the spot image plane in the processing field. By scanning split spots over a target such as an edge, independent energy measurement is possible even for closely spaced spots. However, at full processing RF levels, pulse energy can be high enough to damage the reflective targets. To remedy this and allow the AOBD to operate at full RF power for accurate calibration, an upstream attenuator can be used to reduce split pulse energy to an acceptable level where calibrations targets are not damaged. Since total energy of the split beams can be measured with the in field detector, absolute power measurement of each split beam is not strictly required. Relative measure of each spot's energy in conjunction with the total energy can be used to determine each spot's absolute energy. Generally the split ratio or energy balance is the primary calibration concern. This relaxes the requirement of the upstream attenuator so that a non-damaging energy range can be set for calibration with reflective targets without requiring a precise upstream attenuation adjustment.

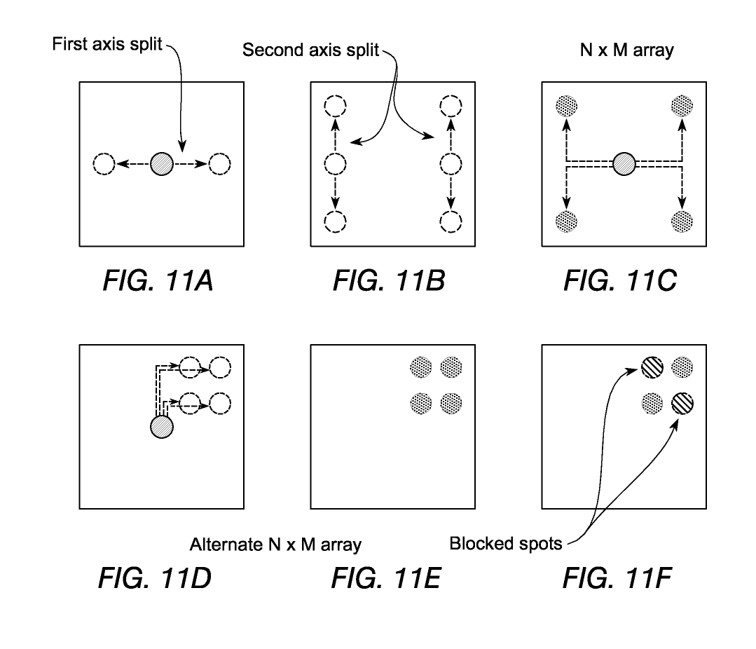

Splitting the laser beam successively with a pair of AOBDs in the optical path generates an N×M array of spots. As illustrated by FIGS. 11A-11F, a beam can be split along a first axis to form two or more individual spots and then further split along a second axis to form the array of spots. FIG. 11A represents an example of a first axis split of the beam. FIG. 11B illustrates a second axis split of the beam. The two-axis split may be used to form an N×M array as shown in FIG. 11C, alternate N×M arrays as shown in FIGS. 11D-11E. Spot placement for multiple spots that are subsets of an array of spots requires a blocking scheme for any undesired beams. For example, two spots staggered at an angle with respect to the AOBD axes can not be generated with out some form of blocking as each axis would independently split the beam and a 2×2 array containing the two desired beams and 2 undesired beams as shown in FIG. 11F. Considering this added complexity, beam splitting may advantageously be limited to a single AOBD axis. Of course, as discussed, beam rotation or AOBD orientation can provide two or more angled spots in the field.

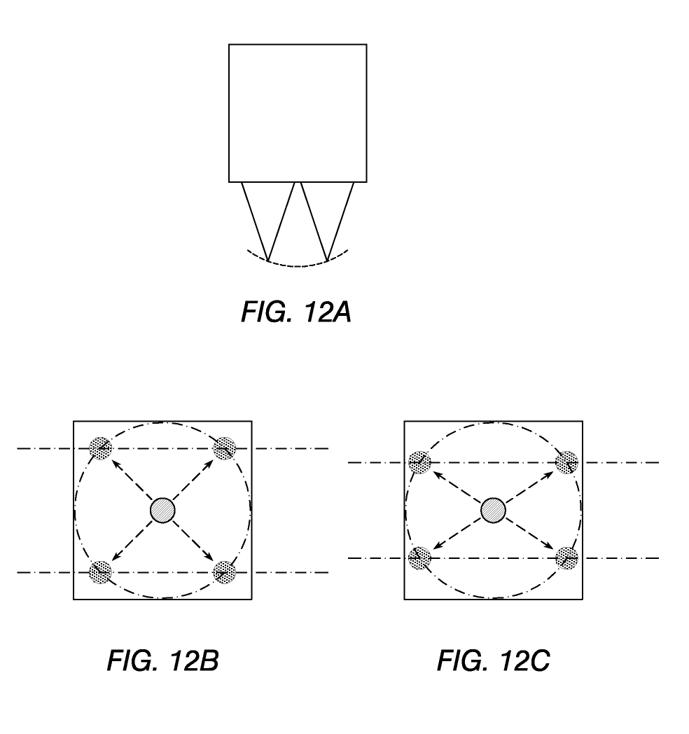

In some cases, the objective lens may have residual field curvature and an annular field can be addressed. In this case it is preferred when splitting and directing the beam axis to two rows, to dispose the lens axis relative to the row position such that focus height of each row falls within the annular field and preferably on a focus common plane as shown in FIGS. 12A-12C. Z height adjustments can be used in cooperation with the spacing between spots such that focus is maintained in multiple spots as spacing is changed. As shown in FIGS. 12B and 12C, when more than two spots are used, for example 4 spots, the multiple spot positions relative to the lens may fall into a ring field of view. A ring field of view may be of particular interest for large separations between spots. Separation can be adjusted at points on a diameter falling within the ring. It is possible to use multiple blasts with a ring field, for example, 2 blasts one at each intersect on the diameter and the offset dimension.

### Pointing Errors

Beam steering with AOBDs may be used to calibrate other pointing errors introduced in the optical system. For example, motion of zoom beam expander elements or other optical elements can generate repeatable pointing errors. Correction of repeatable pointing errors can be accommodated with pointing corrections applied with the AOBDs. In the zoom beam expander example, AOBD can be used with an appropriate correction look-up table to maintain pointing accuracy through the zoom range as spot sizes are changed.

### Sub-Field Selection

Considering the complexity and subtlety of multi-axis AOBD calibration, there may be characteristic deflection field regions that can be more accurately and reliably calibrated and regions that are less accurately and less reliably calibrated. Analysis of field calibration fidelity can be used to identify preferred areas within a calibration domain. A laser processing sequence may be generated to use these preferred areas while avoiding other areas in the calibration domain. In effect, a sweet spot of field calibration is identified and exploited for increased processing performance. For example, characterization of AOBDs may identify angle ranges where efficiency has good linearity especially regarding variable RF power ranges used for attenuation. Even when performance is acceptable across the entire field, a selected portion of the field may be used for the convenience of limiting calibration requirements. A combination of trajectory planning and blast sequencing within the deflection field can be used to effectively avoid areas having lower performance or use only calibrated areas. The field portion or portions used should access all laterally offset blast locations and include sufficient length in the direction of motion to accommodate large scale pulse timing adjustments (e.g. link phase adjustment).

FIGS. 13A-13D show various field orientations and shapes as they progress along a trajectory. FIG. 13A shows the progression of a nominal square field. FIG. 13B shows a tilted field whereby the field diagonal provides for a wide lateral access dimension. A sub-field example shown in FIG. 13C is diagonal strip with a reduced area that maintains access to the full field width and access of at least one link pitch in the direction of travel. An arbitrary sub-field shape is show in FIG. 13D, whereby full lateral access is maintained within a preferred region, such as a stable calibration region. Other desirable field shapes such as round fields may be used.

Sub-field shape may also accommodate shapes such as ring fields. For example when the objective lens has residual field curvature, an annular sub-field may be selected to limit processing to areas of best focus. Useable width of such an annulus may depend on spot size, for example a narrower annulus with smaller spots. Diameter of the sub-field annulus may vary with target distance. Other focus characteristics, such as irregular variations in focus or spot quality over the field of view may be used to determine sub-field shape selection.

### Spot Shaping

As discussed in 20090095722, multiple frequencies can be used simultaneously for spot shaping. In a multi-axis AOBD system, shaping can take place in either axis to provide very rapid, pulse to pulse spot shape orientation. In a group of links having mixed orientation, this would allow spot shaping in concert with random access. Spot shaping can be extended to multiple spot dimensions, for example to rapidly form more square spots shapes or change the effective spot size in a sequence of pulses. These techniques might be applied for preheating, cleaning or other multiple pulse processing regimes.

### Scanning Techniques

One method of processing closely spaced links uses bursts of sub-pulses fitting within an envelope to allow standard constant motion substrate positioning while the burst is applied to a link. The length of the burst may be short enough to avoid so called pulse smearing effect whereby movement of the spot position during the burst exceeds a positional tolerance and compromises the energy window of the laser process. Aspects of U.S. Pat. No. 7,394,476 are directed to compensating for relative motion between a link and a burst of sub-pulses so that long burst periods can be used without adversely affecting the processing window.

With implementation of a fast inertialess two axis addressable field, further improvements in burst type processing are possible. Without reducing the processing rate, by processing multiple rows or other dense groups of links in a simultaneous trajectory, the velocity of the spot relative to links can be reduced. For example, if 4 rows are processed with a single spot, then the relative velocity of the link and spot can be reduced as much as 4 times. At slower relative velocities, longer bursts are possible without using link tracking techniques. For example, a 500 ns long burst may be the limit in high speed positioning systems that do not employ link tracking. However, when the relative velocity is reduced by a factor of 4, the burst length can be proportionally increased up to 2 us. To the extent that the AOBD access time permits, longer bursts can be used without affecting throughput.

Application 2009/0095722 incorporated in its entirety, describes many aspects of link processing with AOBD scanning that may be used in the current invention. In one embodiment a scan axis is tilted in relation to wafer motion, for example tilted at a 45 degree angle. Among other benefits, tilted scanning can allow high speed access in multiple axes with a single inertialess scanner, spot shaping along a link, alignment with staggered link arrangements and control of telecentricity error. In other embodiments, an acousto optic device is thermally stabilized by driving with a near constant rf power.

### Processing Regimes

Embodiments of the present invention using further aspects from published US patent application 20090095722 may include asynchronous processing; that is to say the product of link pitch times velocity may not correspond to the PRF. In at least one embodiment, for improved throughput, all links processed and unprocessed, will pass through the processing field at a rate exceeding the PRF with improved utilization of available pulses that are directed to links selected for processing. Processing may include mixed pitch layouts of links, for example moving along a trajectory a constant velocity and processing a variety of link pitches. Mixed phase is also possible, where groups of regularly spaced links may not be laid out on an overall regular pitch. Mechanical pitch phase adjustment from group to group can be accommodated with the inertialess deflectors. Channeled processing as described in the US Patent Publication 20090095722, using a discrete set of deflections may be beneficial when a limited number of RF frequencies are available for rapid switching. In this case a preselected frequency corresponds to each discreet processing channel. These processing regimes among others, deviating from tradition equally spaced links in a single row, can be applied to various layouts of single or multiple rows with the benefit of inertialess positioning.

### Position Error Correction

Two-axis AOBD positioning provides a convenient way to correct for either positional or temporal errors in a link blasting process. Positional errors, measured, calculated or estimated can be summed with two axis deflector position commands to correct the errors on a pulse by pulse basis. In addition, AOBD positioning can be used along the trajectory path to correct for temporal errors and delays, such as trigger timing adjustments. In much the way that convention laser processing systems correct position with temporal adjustments of the laser firing time, a blast firing error or adjustment can be accommodated with a corresponding position adjustment in the direction of travel.

Various error correcting aspects of AOBD positioning may, in some cases, allow higher dynamic positioning speeds where positional errors are increased and compensated. Also, since AOBD positioning with error correction can eliminate the need for pulse to pulse timing corrections, constant laser repetition is possible. Instabilities resulting from irregular pulse timing are therefore eliminated and stable laser pulse energy can be supplied, potentially at increased pulse rates where error adjustments are made in the AOBD positioning command.

Error correction can include predetermined errors that have been characterized and are applied by the controller to correct for known, planned or expected positioning occurring errors. Error correction may include estimated errors where a parametric model is used and based on process parameters an error is estimated for correction. Errors may also be measured directly in real time for correction.

Error limits may be used as input for trajectory optimization. For example a trajectory may be planned to keep errors within a range that can be corrected in the field of inertialess deflectors or within a specified tolerance band. Actively measured errors can be monitored and modifications to trajectory can be made when the measured error exceeds a predetermined level. For example, velocity may be slowed to maintain errors within a correctable range when a target error limit is approached or exceeded.

### Optional K-Mirror

Aspects of beam rotation are generally described in Published US application 20090095722. The beam rotation can be used with single axis deflection to accommodate 2 dimensional field access in a polar coordinate fashion. In this case, as is well-known the output beam rotation angle is two times the beam rotator angle. When 2-axis deflection of a single beam is used, the system may be configured without a beam rotator and skew errors resulting for rotational misalignments of deflection axes can be calibrated out with a coordinate transformation. However, it may be desirable to include one or more beam rotators even when single beam two-axis deflection is used. This may also be used, for example, in conjunction with beam splitting. When beam splitting, the orientation of the plane of the split will be determined by the rotational orientation of the deflector along the beam axis. Of course, each deflector might be rotated directly, or a beam rotator might be used to align the deflecting and split axis with alignment feature or targets to be processed in the addressable field. With multiple deflectors, it is possible to use multiple beam rotators so that each deflector can be independently aligned. In practice, deflection axes can be relatively aligned to acceptable tolerance, for example so that field axes are orthogonal. In this case only a single rotator is used to adjust the orthogonal deflection field skew to mechanical beam positioning coordinates. The beam rotator can be any type known such as a Pechan prism or Dove prism, however, in a preferred arrangement; a K-mirror with three first surface mirrors is used. The K-mirror essential provides a large aperture hollow dove prism that can rotate one or more deflection axes without using large blocks of transmissive material. Advantageously, one or more reflective surfaces of the K-mirror can be adjusted to null out beam pointing and or beam offset errors. Such a K-mirror may be manually operated or may be motorized for automated adjustment or rotation. The K-mirror may be removable from the beam path and may be replaced with fixed path optics arranged to maintain axial beam length along the beam path.

### Mechanical Positioning

Conventional processing systems such as the GSI Group M550 include a coarse stage movement for stepping the laser beam axis relative to the substrate from region to region. Stepping may be from a single device to a single device, from a part of a device to a different part of a device, or from a processing site that includes more than a single die to a different processing site. The coarse stage remains stationary during processing. While the coarse stage remains stationary, the fine stage positions the wafer relative to the beam axis according to a trajectory planned to process selected links in the local region of the wafer. When the trajectory is complete the coarse stage steps to a new region. The time penalty of repeated steps, lockdown of stepped optical components and alignment is offset by high-speed positioning of the wafer with the fine positioning stage.

Yet another conventional system uses a pair of long travel stages in a split stage architecture. One axis moves the optical axis while the other axis moves the wafer. A first axis is stepped to a location corresponding to one or more rows of links on the wafer. The orthogonal axis is then scanned at high velocity, generally along rows across the entire wafer and alignment may include may dice across the wafer. This provides for long stage motions at velocity, but heavy stages limit acceleration capabilities between link groups and at the edge of the wafer.

Other configurations are possible with various combinations and permutations of substrate and beam positioning to produce relative motion between target structure and the processing spot. Regardless of the configuration, generally coarse movement will be associated with relatively infrequent high inertia positioning. Coarse movement, especially considering acceleration and deceleration, can generate system perturbations. These perturbations may include for example mechanical vibration, center of gravity shifting, thermal loading, air turbulence, and electrical noise. In a step and settle regime, perturbations are allowed to attenuate over a settling period, and processing proceeds when a predetermined performance level in achieved. Various methods can be used to mitigate system perturbations as are known in the field of precision engineering. For example, force cancellation as disclosed by Cahill, et al. in U.S. Pat. No. 6,144,118 can be used as a means to mechanically counter acceleration forces. Moving mass can also be used to maintain balanced static loads on isolated support systems.

Some form of fine positioning is generally used for link processing to provide sufficient bandwidth for a high throughput system. As mentioned, a small travel fine stage can be used in conjunction with a large travel coarse stage. The fine stage may be for instance a 50 mm×50 mm travel moving magnet stage supported on a planar air bearing. In this case the coarse stage addresses the full wafer, which may be a 300 mm diameter wafer, in increments of 50 mm or less. With long travel linear stages covering the entire length of the wafer a fast steering mirror has been used to provide high bandwidth error correction.

Methods and systems of the present invention can be characterized as a superfine positioning providing access over a small field, generally smaller than a single die and larger that a single link, that can position laser blasts within the field on a blast by blast basis. In addition to throughput improvements, a superfine positioning system can correct dynamic errors, control relative beam to target velocity, and split a beam to multiple superfine positioned beams.

### Field Size Selection

Conventionally, trajectory planning is largely independent of spot size and there is no deflection field to consider. However, when there is a deflection field and the dimension of the field can vary, as shown in FIG. 6, such as when the spot size is varied or if the field size is reduced to operate in a selected calibration range or for other reasons, trajectories may be planned based on a selected deflection field size to be used. For example if the field size changes for a different spot size, the trajectory may be planned accordingly so that the number of simultaneous rows to be processed is selected based on the deflection field size. Larger fields may allow greater error margins within a range of correctable errors, higher velocities, more efficient path planning and so on. Smaller fields may allow improved calibration of deflector efficiency and other effects, and thus trajectories may be planned to accommodate the small field.

### Buffer

During a trajectory segment, links selected for processing enter and subsequently exit the deflection field. As the field moves relative to the substrate, links can be addressed and blasted at different positions in the deflection field from the point where a link enters the field to a point where the link exits the deflection field. The range of positions in the field where links can be blasted is in effect a spatial buffer that can include multiple addressable links at different positions when a laser pulse is available for blasting. Based on the size of the deflection field and the relative velocity between the substrate and the field, there is an associated time interval during which a link selected for processing dwells in the deflection field. A link can be blasted by any one of a number of different pulses in a pulse sequence that occurs over the interval. Therefore a deflection field of appreciable size can be considered as either a spatial buffer or a temporal buffer. During relative motion of the deflection field and the substrate, unprocessed links can accumulate in this buffer for processing with available pulses before exiting the deflection field. A maximum PRF of the laser source will limit the number of links that can accumulate in the buffer (not considering multiple simultaneous beams),

Various advantages of link buffering in a two axis deflection field can be used for trajectory planning. As a spatial buffer, leading or lagging links can be sequenced according to preferred trajectory scenarios. As a temporal buffer, link blasts can be advanced and delayed to provide improved laser utilization. In some cases, the buffer size may be exceeded and unprocessed links can processed during subsequent, partially overlapping passes. For example links from isolated dense groupings of links can be deferred and processed later in areas adjacent to relatively sparse processing areas.

### Trajectory Planning and Velocity Optimization

Techniques such as shortest path problem algorithms and the like are possible for finding the optimal velocity. Generally, throughput will be limited by either a maximum PRF or a maximum stage velocity Vmax. When pulse rate limited, the optimum solution will process a group of links with fewest possible pulses and when stage velocity limited, the maximum velocity be the optimum velocity unless other constraints indicate a reduced velocity.

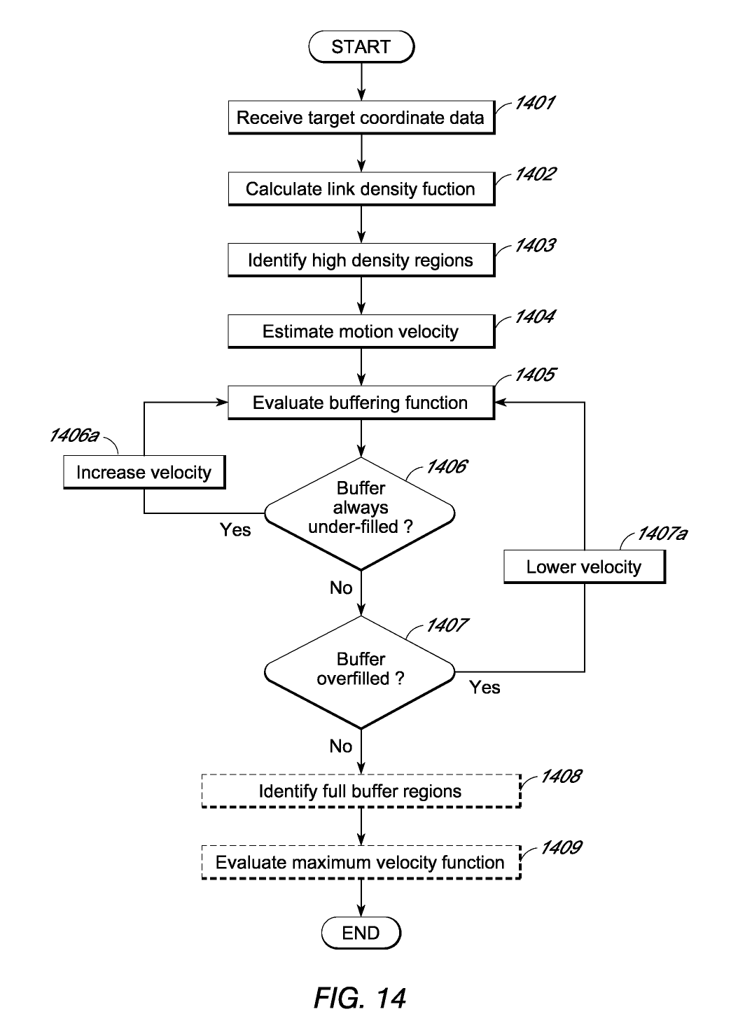

In one embodiment, a buffering function is used in an iterative optimization technique to determine a maximum velocity as shown in FIG. 14. For example, with reference to FIG. 14, target coordinate data may be received at block 1401. A link density function may be calculated at block 1402, and high density regions may be identified at block 1403. A motion velocity may be estimated based on the density of the identified regions at block 1405. A buffering function is evaluated at blocks 1405-1407. For a trial velocity, un-blasted links accumulate according to a buffering function when links enter the deflector field faster than they can be processed. If the buffer overflows, the velocity is too high and lower trial value is used as represented by block 1407a. If the buffer is always under filled, velocity is too low and a higher trial value is selected as represented by block 1406a. There may be a set of velocities that fully fill the buffer. At block 1408, the method may determine the full buffer regions. A fine iteration step may used to determine the maximum velocity within a specified tolerance as illustrated by block 1409. For example, a buffer function may represent the sum over trajectory segments Bₙ, where n represents a next blast period. If the number of links entering the field in the next blast period n is represented by Mₙ, the buffer function may be represented as Bₙ₊₁=Bₙ+Mₙ₊₁−1 when Bₙ>0. The buffer function may be represented as Bₙ₊₁=Mₙ₊₁ when Bₙ=0.

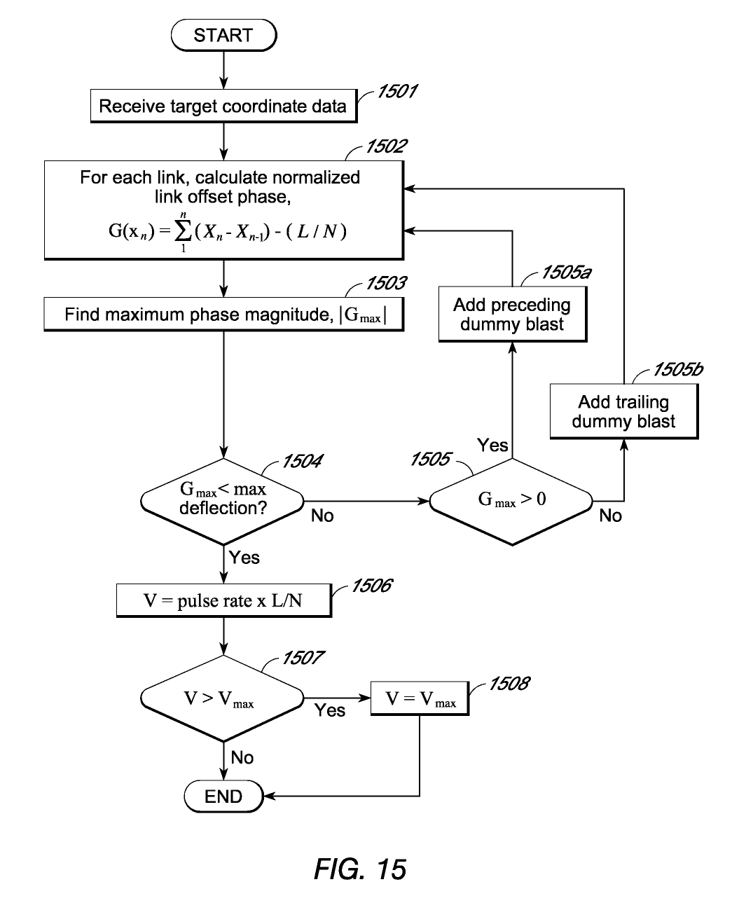

In another embodiment shown in FIG. 15, an accumulated normalized phase function is calculated over a sequence of selected links in a link group. At block 1501, target coordinate data is received. For each link, a normalized link offset phase may be calculated as illustrated in block 1502. The normalized link offset phase may be calculated according to equation 1 below.

$$G ( {x}_{n} ) = {\sum }_{1}^{n} ( {x}_{n} - {x}_{n - 1} ) - ( L / N ) \qquad ( 1 )$$

As shown in equation 1, G(xₙ) may represent the normalized phase offset link function, L may be set to x_{N} which is equal to the length of the segments, xₙ is equal to the linear position of each sequenced link, and N is the number of blasts. The number of blasts N is set to include the number of links in addition to a number of dummy blasts. Where the phase exceeds the deflector field limits, non-processing blast sites (dummy blasts) are added adjacent to phase maxima to locally reduce the phase offset in a smoothing routine until all selected links fall within the deflector field during a constant velocity motion segment. The addition of pulses can accommodate phase adjustment and attendant warm-up pulses for the first re-phased link by using fractional spacing in addition to regular spacing. The goal of this optimization is to find a minimum number of laser pulses required for processing a group of links in space. Additional routines according to this embodiment may include adjusting end point location within the deflection field to set initial conditions or to provide fine optimization after a minimum number of pulses is determined.

With reference to FIG. 15, a method may include finding a maximum phase magnitude |Gₘₐₓ| at block 1503. At block 1504, the method may determine whether |Gₘₐₓ| is less than a maximum deflection amount. If |Gₘₐₓ| is greater than a maximum deflection, it is determined whether Gₘₐₓ is greater than 0 at block 1505. If Gₘₐₓ is greater than 0, a trailing dummy blast is added at block 1505b. If Gₘₐₓ is less than 0, a preceding dummy blast is added at block 1505a. A phase function is subsequently re-determined at block 1502. On the other hand, if |Gₘₐₓ| is less than a maximum deflection, a velocity is set as a pulse rate x L/N as represented by block 1506. The method proceeds by determining whether a velocity V is greater than a maximum velocity Vₘₐₓ at block 1507. If the velocity is greater than a maximum velocity, the velocity is set to a maximum velocity at block 1508. If a velocity is less than a maximum velocity, the determined velocity is applied as the optimized velocity and the method ends

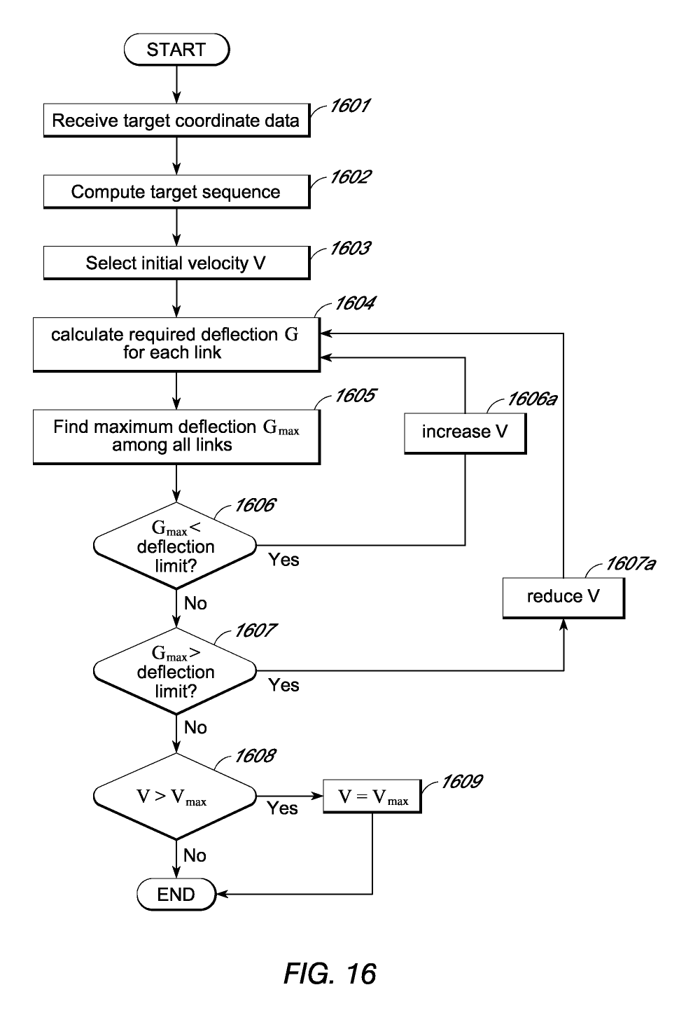

In a further embodiment as shown in FIG. 16, target coordinate data is received and a target sequence is computed at block 1601. Next a computed target sequence is determined and an initial trial velocity is selected and the required deflection for each link is calculated based on a computed target sequence and the initial velocity at blocks 1602-1604. From the calculated offsets, the maximum offset Gmax is found at block 1605. Gmax is compared with a deflection limit value δ at block 1606. If Gmax is less than δ, then the trial velocity is increased as illustrated by block 1606a, and if Gmax is more than δ, then the trial velocity is decreased and new deflections are calculated with the new trial velocity until Gmax equals δ as illustrated by blocks 1607-1607a. According to this optimization routine, the optimum velocity occurs when Gmax equals δ, and the velocity is set to the lesser of V and Vmax as illustrated by blocks 1608-1609.

When PRF is high, and/or the positioning velocity slow, such that the velocity is at or below a maximum velocity where all selected links can be processed in a single pass, one can use a “fire at will” strategy. This scheme blasts targets along the trajectory axis in the same sequence as they enter the deflection field. Targets are blasted when they come within the field of the deflector, i.e. as soon as they become accessible. When multiple targets enter the field simultaneously, these targets can either be sequenced or processed simultaneously with multiple beams.

### Diagonal Field

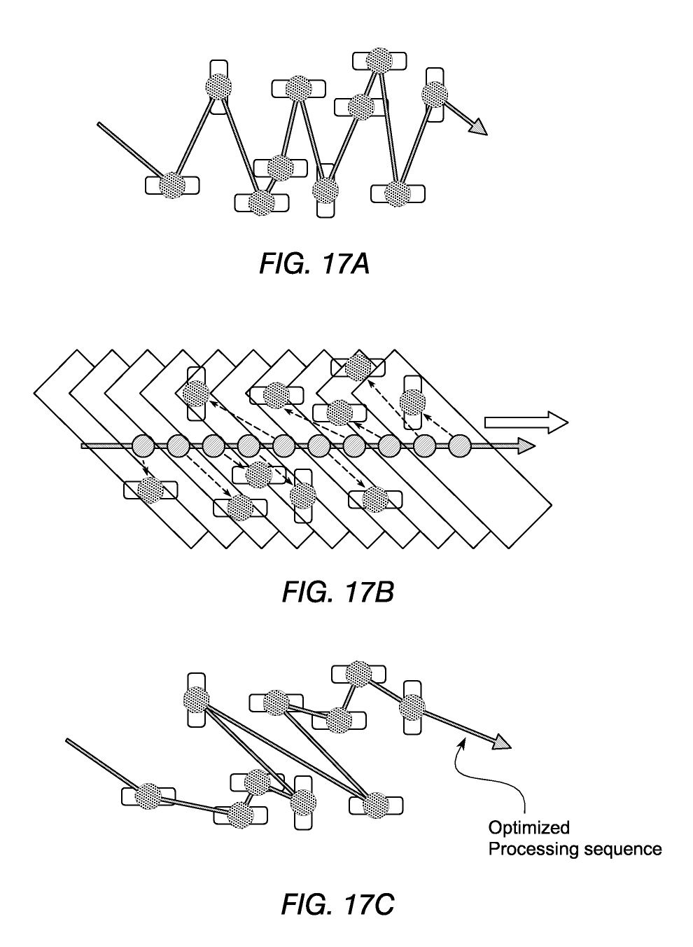

A diagonal deflection field allows a single high speed deflector to process links spaced apart in different axes, for example Cartesian X and Y axes. Processing on the diagonal allows system operation without requiring different modes of operation for different axes as may be required when switching from an x offset to a y offset (e.g. modifying deflection orientation with a beam rotator or selecting from branched optical paths). Errors resulting from reconfiguration and subsequent requirement for recalibration are avoided. As show in FIGS. 17A-17C, trajectory planning may take into account the diagonal field, for example, to start processing a group of links at a preferred edge of the field to minimize length of one or more processing segments. The nominal processing sequence and path is show by way of reference in FIG. 17A. FIG. 17B shows a rectangular field in a diagonal orientation progressing across the group of links. A set of offset values is determined for the diagonally oriented rectangular field. FIG. 17C shows the resulting processing sequence and path that accommodates the field; when compared with the nominal path, it is readily apparent that a completely different sequence can be used based on specific parameters of the field. This technique can be applied on a large variety of scenarios to optimize the processing sequence. Other factors used to group and sequence links may include a minimum non-processing gap, maximum field width, bounding area of a group of links, density of links in a group, processing velocity of a group, and mechanical trajectory.

### Processing Rate Optimization

In conventional link processing systems, the laser processing rate is simply the substrate velocity divided by the link pitch. In terms of actual links processed, an effective link processing rate over a processing segment can be calculated by multiplying the conventional processing rate times number of links processed divided by number of links traversed. Generally, a fraction of links is processed and the resulting effective link processing rate is low compared the PRF.

With more efficient processing and higher relative motion velocities, the effective processing rate can be increased. One measure of link processing efficiency for a link group is the number of processed links (LP) divided by the total number of laser pulses (PTotal). The upper efficiency limit is 1 when LP=PTotal and all pulses are used to process links. Various embodiments disclosed provide for increased efficiency and therefore a higher link processing rate.

At a conventional processing velocity, throughput can be increased by simultaneous processing of multiple rows and shortening the overall trajectory by eliminating multiple passes over the rows. In the case where multiple links require processing at the same time, either the beam can be split to provide multiple processing spots or a preceding or subsequent laser blast can be used out of sequence with a spatial offset in the field along the direction of travel to blast the link. The blast selected might be the nearest available blast either preceding or following the nominal blast time, but other blasts can be used. To the extent that blasts are available, this can provide a doubling of throughput when 2 rows are processed simultaneously or a factor of N when N rows are processed simultaneously.

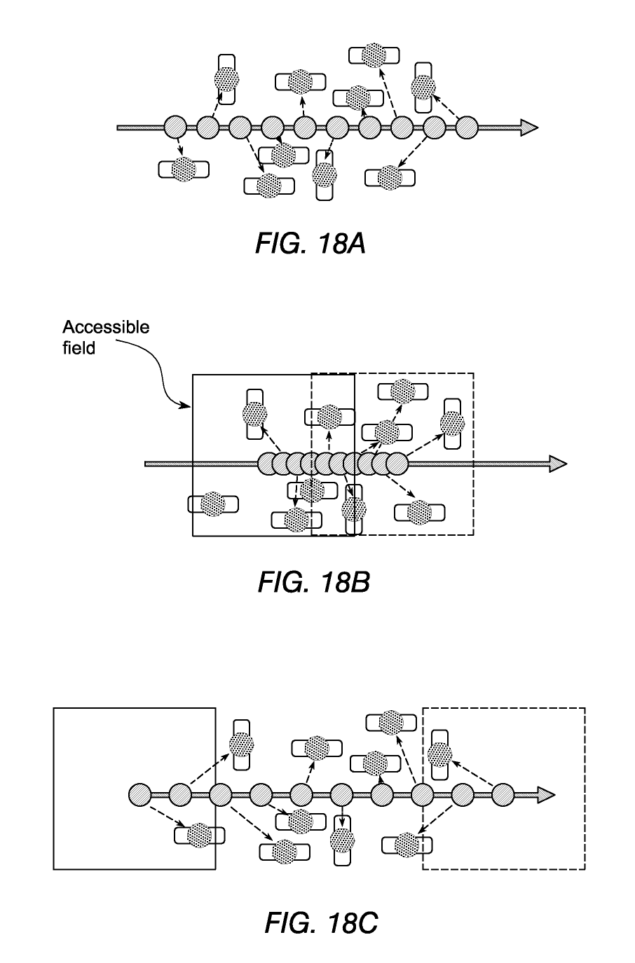

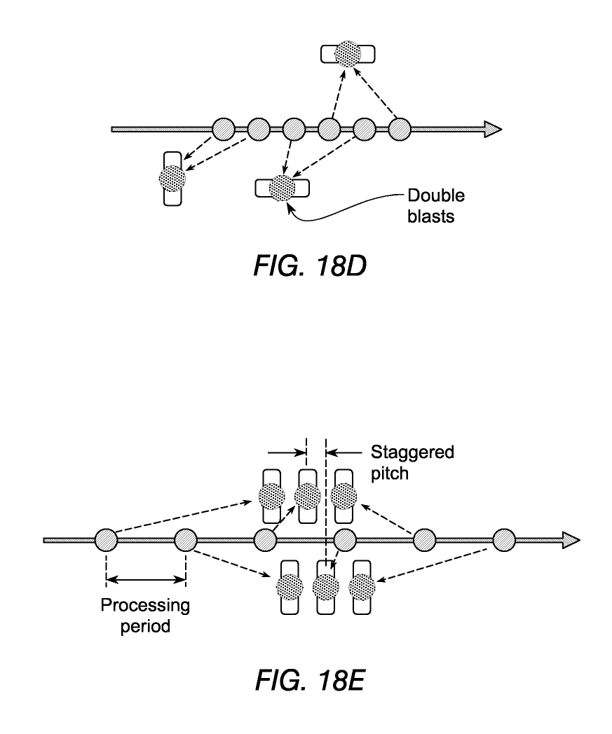

One aspect of random access inertialess positioning is the ability to perform laser processing at velocities different from conventional velocities and increase the effective processing rate. If the local density of links to be processed within the addressable field exceeds 1/N links per column, then there may not be enough available blast times. In this case, translation speed of the substrate can be slowed to provide more blast times until there are sufficient pulses available for complete processing. When the velocity is reduced, the random access field allows an arbitrary velocity to be used with correction to most if not all pulses. In a conventionally synchronized system a slowdown would be limited to an integer increment to maintain synchronous processing, e.g. ½ speed or ⅓ speed etc. FIGS. 18A and 18B show a processing trajectory and offset targets to be processed and a nominal velocity and the same targets using a different set of offsets when the trajectory velocity is slowed down. It will be apparent that an arbitrary speed reduction, as opposed to incremental, is possible while maintaining a constant PRF. The flexibility of an arbitrarily reduced velocity can provide increased throughput by operating at the highest useable velocity.

Not only can velocity be slowed for high local densities, but velocity can be raised for low local density. As disclosed in the 20090095722 publication, various types of buffered processing such a channeled processing and asynchronous processing can be used to increase velocity. Within the limit of various constraints, such as maximum travel velocity and random access field size, velocity can be increased until the average blast density in time matches the process repetition frequency and all accessible blasts are used. This can apply to multiple rows as well as single row processing or randomly placed targets. FIG. 18A represents processing with mechanical trajectory at a nominal trajectory velocity, FIG. 18B represents processing at a reduced or slowest trajectory velocity, and FIG. 18C shows an increased trajectory velocity and a set of target offsets for the increased velocity. Other processing scenarios include double basting as shown in FIG. 18D and blasting of staggered rows as shown in FIG. 18E.

Another possibility to manage high link densities is to designate some links for processing in a subsequent pass. For example, if three rows are to be processed, rather than slowing velocity to process all links in a single pass, one row such as the middle row could be partially processed in a first pass and completed in a second pass. This technique may be especially useful when the spacing of a desired odd number of rows to be processed exceeds the random access field size. For the above example of three rows, rather than processing 1 row and 2 rows in separate passes, each pass can include essentially 1½ rows and average density can be managed to some extent when assigning a processing pass to links in the split row.

A number of different parameters can be used to calculate a processing trajectory velocity or starting values in iterative velocity optimizations. For example an average number of links the in field, an average link pitch, a constant sum of link velocities within the field, a rate of links entering the field, or a rate of links exiting the field may be used to calculate a processing velocity. Likewise a comparison of parameter values may be used, for example the difference between the numbers of links entering and exiting the field may trigger an increase or decrease in velocity to accommodate a respective depleting or accumulating number of links in the addressable field.

Other factors affecting a velocity or an acceleration value may be set based on predetermined parameter values, such as permissible levels of system perturbation.

### Addressable Field Width

In some cases, especially where travel velocity is determined by system constraints, the width of the field accessed relative to the direction of travel may be selected based on the velocity. For example a number of rows or width of the processing field accessed may be determined based on a desired effective processing rate at a predetermined velocity. Other factors affecting choice of width selected may be AOBD efficiency, orientation of links or rows, process window optimization or trajectory optimization.

### Addressable Field Length

In some cases the length of the field accessed relative to the direction of travel may be selected based on velocity and other factors. For example, a shorter length may be selected for use with reduced velocities or increased length may be used with increased velocities. Other factors may include AOBD efficiency, orientation of links or rows, process window optimization or trajectory optimization.

### Predictive Processing

In these deflection systems, position prediction at future laser pulse times can ensure spot placement accuracy at high scanning speeds. Pulse by pulse deflection can be used based on rapid position sampling and prediction of the optical system axis intercept point on the wafer at future pulse times. For example, stage position encoders may be sampled at about a 3 MHz rate, or about every 350 nanoseconds to provide dense position data that is used to accurately estimate the intercept point position at a planned pulse trigger time. For example, with laser pulse repetitions near 300 KHz, the fast sampling rate provides position data much faster than laser pulses are used for processing. Thus, position estimates can be generated at and well above the laser repetition rate and up to the sampling rate, so accurate predicted positions are available for each pulse. An accurate predicted intercept point position can be used to generate corrected deflections relative to the intercept point for each pulse and may be generated, for example, in much less than the 3.3 microsecond time period between laser pulses for a 300 kHz laser.

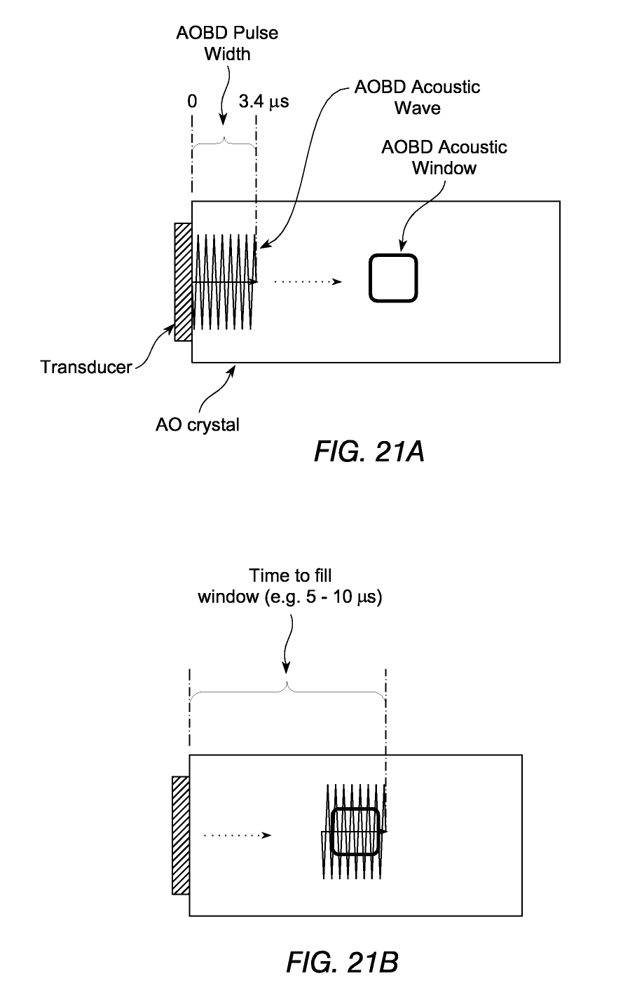

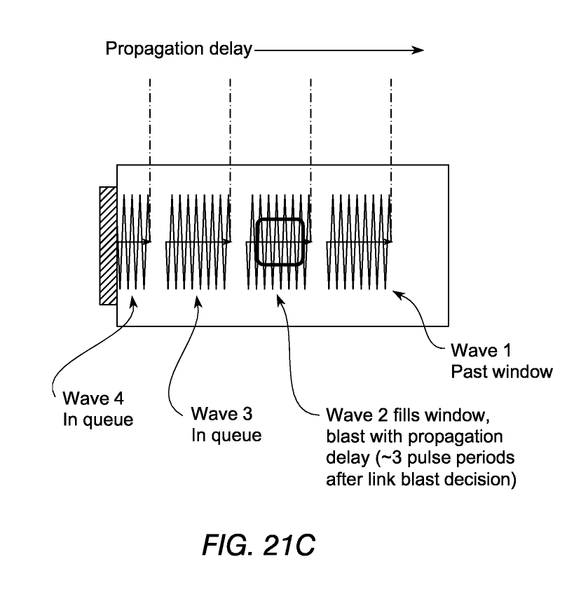

The lead time afforded by predicting the intercept point for an upcoming pulse and rapidly generating corrected RF deflection signals generally accommodates the time required for AOBD acoustic wave set-up. Within each AOBD, there is a characteristic acoustic delay time for the RF generated acoustic wave to propagate through the acoustic crystal to fill the acoustic aperture used for beam deflection. So, the laser spot offset from the intercept point and the associated RF frequency and RF amplitude must be determined in advance of the laser pulse, which may be on the order of 10 microseconds. The delay depends on the acoustic crystal material properties (acoustic velocity) and the AOBD crystal geometry. When high repetition lasers are used such as lasers pulsed at greater than 100 KHz, the pulse repetition period may be less than the acoustic delay time. In one implementation of the invention, rapid sequential pulse transmission can be accommodated by generating RF pulses in advance of corresponding laser pulse deflections and stacking the resulting propagating acoustic pulses in the AO crystal. For example, at about 300 KHz, three RF pulses may simultaneously propagate in the AO crystal and the RF generation may be several pulses ahead of the laser pulse. This aspect is illustrated and described with reference to FIGS. 21A-21C below.

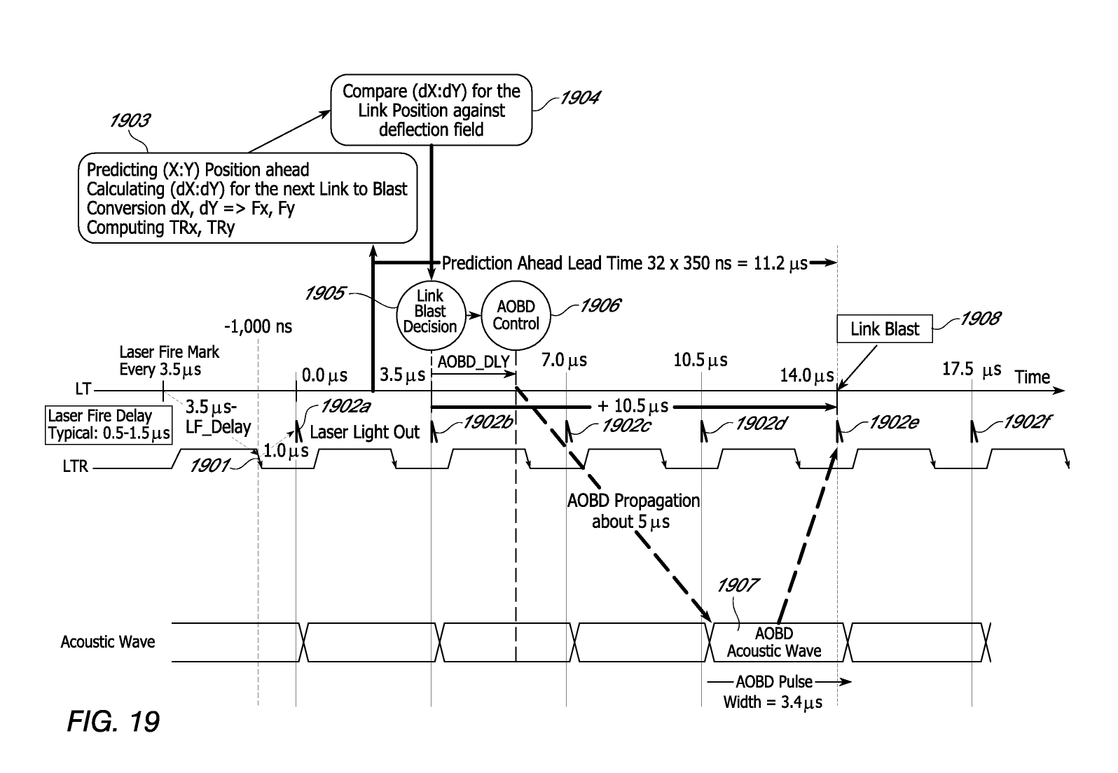

FIG. 19 illustrates a timing diagram of a predictive laser processing system. As illustrated in FIG. 19, a laser may be fired every 3.5 μs as indicated by laser time line LT. This timing corresponds approximately to a 300 KHz laser. A laser pulse is triggered by a triggering waveform as represented by waveform LTR. The laser trigger may occur on the falling edge of a square wave as represented by arrow 1901. A delay may exist in processing the laser trigger signal to fire the laser pulse. The generation of the laser pulse is represented as 1902A-F in FIG. 19. As illustrated, a delay may be represented as a 1.0 μs delay between the square wave trigger pulse 1901 and the firing of the laser pulse at 1908A, but is not limited thereto. FIG. 19 illustrates the process for predictive blasting of a link with laser pulse 1902E. As illustrated in FIG. 19, the deflection parameters for this pulse are computed and the process of deflection initiation is begun about three laser pulse periods prior to laser pulse 1902E.

At a given time, a predictive processing sequence may be initiated as represented by 1903. The predictive processing may include predicting an X,Y coordinate of a future position of an intercept point along the trajectory, in this case, the predicted nominally deflected intercept point for future laser blast 1902E (e.g. the deflection range center position). The predicted position is an accurate position based on the sampled encoder information. The sequence may subsequently calculate relative deflection distances dX:dY along each axis for the link to blast based on the predicted nominally deflected position. These deflection distances may thus reflect the offset position of a deflected beam from the predicted intercept position. The offset position dX:dY may then be converted to frequencies Fx:Fy for the AOBDs to deflect the beam to based on the determined offsets. Subsequently, efficiency for beam transmission may be determined as represented by TRx and TRy to determine the appropriate RF energy to apply to the AOBD at the selected frequencies. Look-up tables or formulas may be used in order to determine RF frequency values and amplitudes corresponding to the amount of deflection desired and the desired pulse energy for blasting a link.

As represented by 1904, the predictive processing sequence may include a comparison of the offset position (dX:dY) with a deflection field. At 1905, the system may determine whether a link blast should be executed with this pulse based on the comparison of (dX:dY) with the deflection field. If the offset position lies outside of the deflection field for links under consideration for blasting, the system may determine that the laser pulse should not be used for link blasting. For example, the laser pulse may be left un-deflected and picked-off, attenuated or deflected to a dump position where no processing of links occurs. If the position is within the deflection field, the sequence may continue to 1902 to initiate AOBD control for laser pulse 1902E. As illustrated in FIG. 19, an AOBD delay (AOBD_DLY) may exist for generating a required electrical RF output from the power supply. This delay may result in part from the time required to compute the desired frequency and amplitude of the electrical driving signal and generating the RF drive signal from a power supply for driving the transducer. This delay may for example, be about a 2 μs delay. Following this delay time, an AOBD acoustic wave is generated at 1907.

The AOBD acoustic wave may require a predetermined amount of time to enter the AOBD deflection window. For example, this time is represented as a 5 μs propagation time to begin entering the AOBD deflection window as will be described in greater detail with reference to FIGS. 21A-21C below. Once the acoustic wave is fully present in the acoustic window, the link is severed at 1908 with laser pulse 1902E.

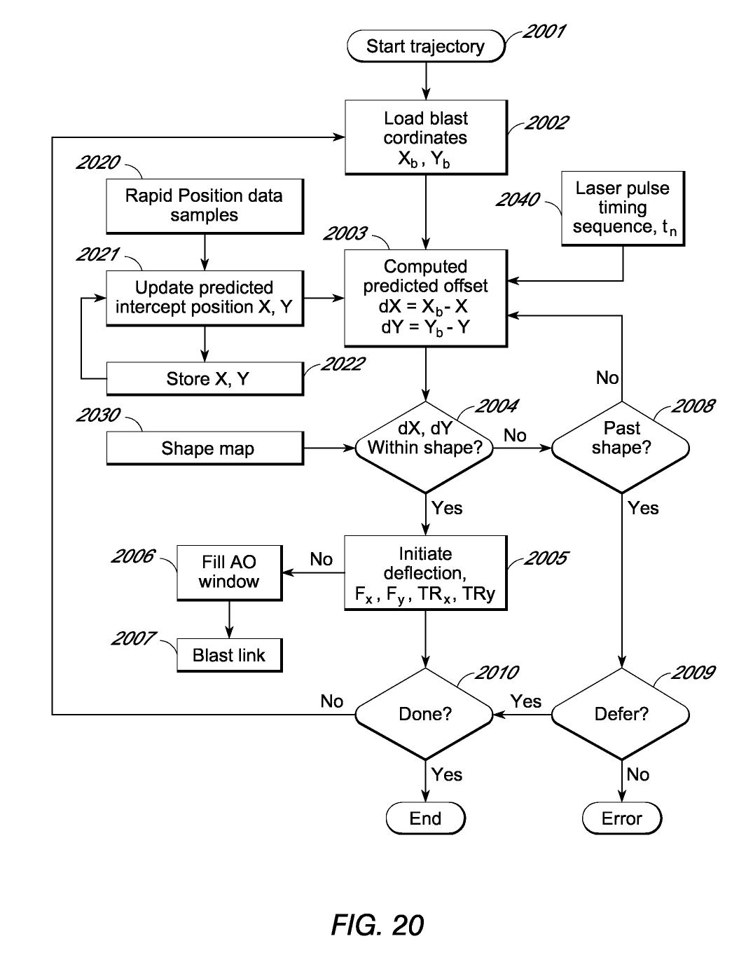

A method of predictive processing according to some exemplary implementations will be described with reference to FIG. 20. At block 2001, the method begins with an initial trajectory based on a motion profile. At block 2002, a set of blast coordinates is loaded. For example, the blast coordinates may correspond to a link position near a future intercept point position along the trajectory. Blast coordinates for a selected link are represented as X_{b}, Y_{b} in block 2002. The blast coordinates may represent coordinates of several links such as the coordinates of each link of a different row in a column of links. At block 2003, the method may subsequently calculate offset positions dX:dY for one or more future links to blast based on the updated predicted position X, Y and on pulse timing information received from block 2040. These offset positions may reflect the offset of a link to be blown from the predicted position of the system optical axis relative to the workpiece at a future time at which a given laser pulse will be generated as discussed above. The offset positions may be based on a set of rapid position data samples that produce continually updated and stored X, Y intercept point positions from newly acquired position data samples as represented by blocks 2020, and 2022 respectively. The samples may be used to update the predicted intercept point of the optical system axis at the workpiece which may correspond to the predicted nominally deflected position within a predetermined error. The updated predicted intercept position may be stored as illustrated in block 2022.

The offset positions dX:dY may be compared with a particular deflection field shape at decision block 2004. The particular deflection field shape may be stored in a shape map as illustrated by block 2030. The method may load the coordinates of the deflection field from the shape map 2030 and compare the offset positions dX:dY with the loaded coordinates. If the offset positions are within the deflection field shape, the method proceeds to block 2005 by initiating the deflection of the laser-beam. The method may initiate the deflection by filling an AO window with an AOBD acoustic wave as will be described with reference to FIGS. 21A-21C below. An AO acoustic window is filled with the AO acoustic wave at block 2006, and a link is blasted with the beam at block 2007. The method may then proceed to determine whether the current processing run is complete at decision block 2010

If it is determined that the offset positions dX:dY are not within the deflection field shape at decision block 2004, the method proceeds by determining whether the link to be processed is past the field shape at decision block 2008. The offset positions may be outside of a deflection field shape in one of four possible positions. The offset position may be outside of the shape on either side, or laterally, with respect to the trajectory. The offset position may also be before or past the deflection field along the trajectory. The system may check whether the beam and corresponding deflection field shape is past the offset position of the link to be processed along the trajectory. If the beam and corresponding deflection field are past the offset position, the method may determine whether the link position to be processed should be deferred to a next processing pass at decision block 2009. If the link cannot be deferred to a next processing pass (for example, the system will not make additional passes in the vicinity of this link position), the method produces an error output. If the link can be deferred, the method determines whether all processing has been done at decision block 2010. The processing may be done when all links to be processed have been processed. If the processing is not done, the method may loop back to block 2002 to load one or more additional blast coordinates at block 2022. The blast coordinates may correspond to a link position to be blasted at a time corresponding to a future laser pulse as discussed above.

If it is determined that the offset position is not past the deflection field shape at decision block 2004, the method may loop back to block 2003 where new offset positions dX:dY may be calculated.

FIGS. 21A-21B illustrate the propagation of an AOBD acoustic wave according to some exemplary implementations. Following the link blast decision and AOBD_DLY referred to in FIG. 19, the transducer may generate an AOBD pulse having a predetermined width. For example, the predetermined width may have a value of about 3.4 μs, but is not limited thereto. The AOBD acoustic wave requires a predetermined amount of time prior to reaching an AOBD acoustic window. This time is illustrated in FIG. 21B as the time required to fill an AOBD acoustic window. For example, the time to fill the AOBD acoustic window may be equal to about 5-10 μs, but is not limited thereto. The total time from the link blast decision to the filling of the acoustic window may correspond to about 10.5 μs in one implementation such as is shown in FIG. 19.

FIG. 21C illustrates a queuing process of acoustic waves for link processing according to some exemplary implementations. Particularly, this queuing process may be configured to generate deflected laser beams in a predictive processing system discussed above. As illustrated in FIG. 21C, each acoustic wave may propagate through the AO crystal towards an AOBD acoustic window. Wave 1 represents an AOBD acoustic wave which is past the acoustic window. Wave 2 illustrates an AOBD acoustic wave which has filled the acoustic window and can be used for deflecting a laser pulse to a link to be processed. As discussed above, the laser pulse may be used to blast the link following a delay. Each of acoustic waves 3 and 4 are queued such that they will be used to deflect subsequent laser pulses upon reaching the acoustic window. As a result, each acoustic wave is essentially prepared at least a predetermined number of pulse periods prior to the blasting of the link. For example, and as shown in FIG. 19, each acoustic wave may be initiated about 3 pulse periods prior to the blasting of the link for which the acoustic wave is generated.

### Blast on Acceleration

Conventional link processing systems have been used with constant velocity processing. This has been due at least in part to the energy stability provided by a constant PRF and positioning stability provided by constant velocity positioning. When position measurement sampling rates are fast enough to provide real-time or near real time position measurements, and when high speed positioning is available on a pulse by pulse basis, accurate laser spot positioning is possible at or near the PRF. Furthermore, considering that inertialess positioning over a field allows position and time adjustments in a blast sequence, the conventional requirement for constant velocity trajectory segments during a blast run can be relaxed to allow non-constant velocities during a blast sequence. Various applicable advantages of non-constant velocity processing have been described in 20080029491 and U.S. Pat. No. 7,394,476.

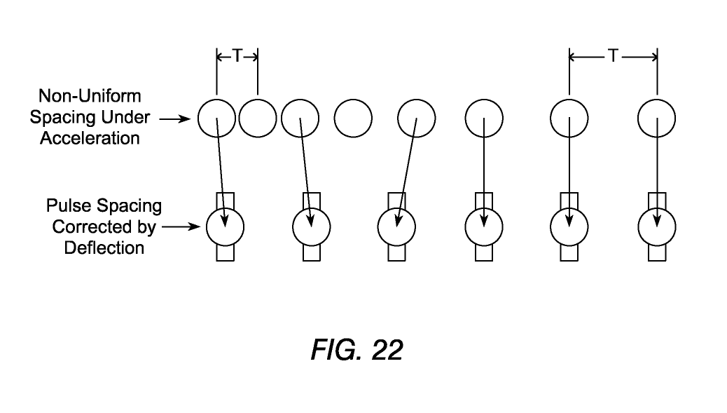

These techniques can therefore be used to accurately sever links during non-constant velocity segments of a beam trajectory. In particular, rapid and precise predictive positioning at or exceeding the pulse repletion rate combined with pulse by pulse deflection are expected to provide non-constant velocity capability. As shown in FIG. 22, during an acceleration segment of a trajectory, a pulse period T will produce a different beam spot spacing between pulses at different points in the trajectory. Beam deflection can be used to correct beam spot position to match the link positions for links to be processed. The ability to process links during acceleration, deceleration, and other non-constant velocity portions of a beam trajectory can reduce processing time.

### Acceleration Due to a Curvilinear Trajectory

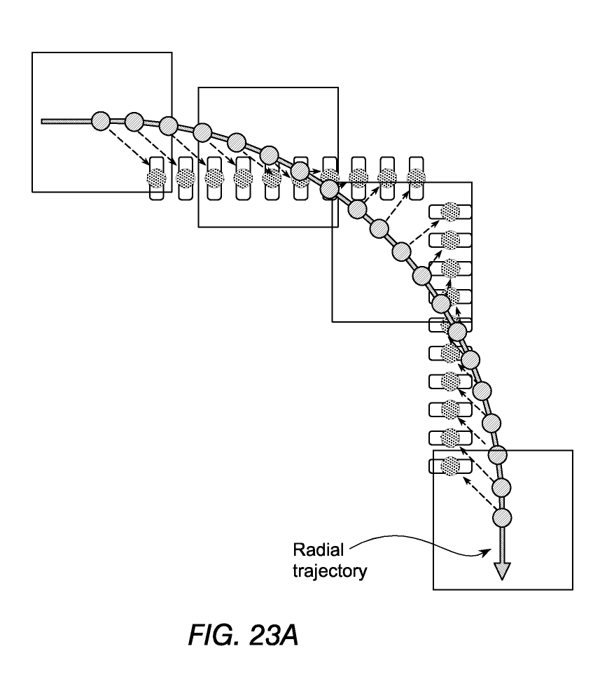

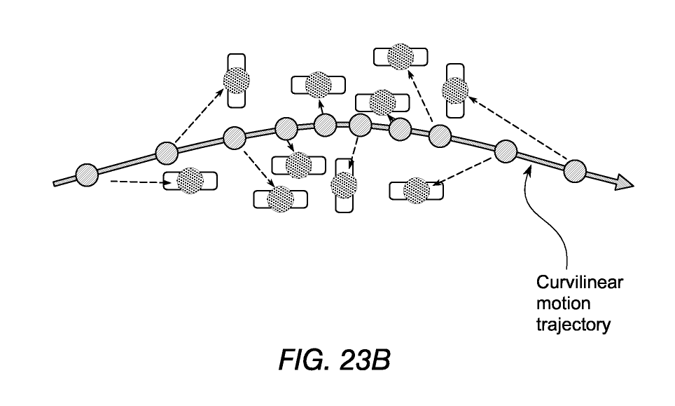

New regimes of trajectory planning can be provided in conjunction with an inertialess deflection field. Since lateral offsets are possible and in general substantial latitude for applying position corrections is available. Curvilinear trajectories or trajectory segments as show in FIGS. 23A and 23B can be used. In a simple example shown in FIG. 23A at the end of a linear group in a transition to an orthogonal linear group, mechanical positioning can implement a curved path while the field accommodates the errors with offsets from the nominal row position. In this way, segments can be truncated with movement to the subsequent segment started before the current segment has been completed. This example also demonstrates that a trajectory with non-constant velocity in one axis may be generated to have a constant radial velocity. For the arc segment trajectory shown, acceleration may be sinusoidal; however other well-known non-constant velocity profiles may be used. As illustrated by FIG. 23A, a constant tangential velocity may be maintained in order to optimize placement of a target in a deflection field laterally and axially. Various aspects of link processing with non-constant velocities are discussed in published application US2008/0029491 A1.

When there are isolated short groups of links, as shown in FIG. 23B these can be processed passing in the sweep of a large radius segment. Considering potential new layouts of links, curvilinear paths may provide wandering or random access to dense and sparse areas of links that are more efficient than conventional linearly segmented trajectories.

### New Link Layouts

Rapid random access spot positioning over links, especially when used with accelerating trajectories, even over modest field sizes, can be used to process non-conventional redundant memory repair link layouts. Many types of link structures and layout regimes are well-known. Generally, design rules are tailored to the laser repair process to achieve a high speed high yield process. To this end, links have been arranged in regularly space groups in rows and columns. At the same time, links are designed to minimize semiconductor real-estate. It is common for links to be grouped along streets in the center of each die. This layout is especially beneficial to large, linear travel processing systems where high throughput relies on wafer scale blast runs. Systems with smaller 2 axis fast positioners are somewhat more flexible, however the benefits enjoyed in both types of conventional systems from constant laser q-rates and constant motion velocities have in state-of-the-art systems resulted in accuracies at the 150 nm level. Not withstanding these benefits, arranging link orientations and positions preferentially for the laser repair process can be at the expense of overall semiconductor real-estate and memory cell complexity. Throughput improvements and increased processing flexibility provided with fast random access spot placement can now be considered in the design and layout of memory devices. For example, mixed link orientations and local location of links near or adjacent to reconfigured cells may be feasible with an improved laser repair process.

### Deflected Beam Axis

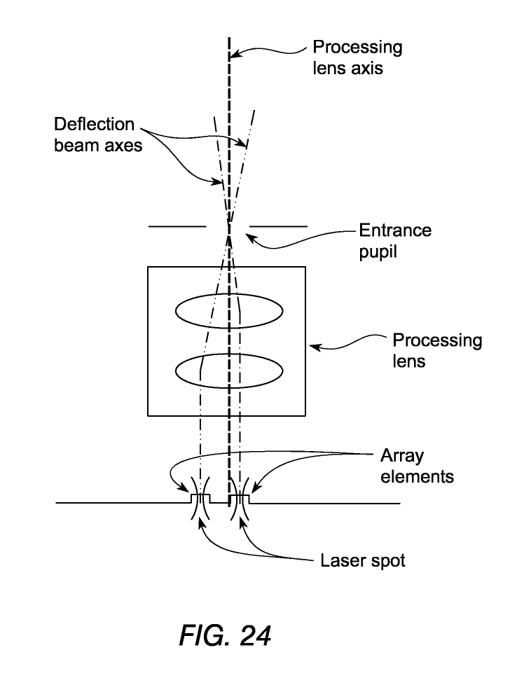

Aspects of certain embodiments may be practiced in a single path optical system where all beams are incident on the same set of optical components. In a single path system multiple beams may be offset from an optical path axis propagating with non-collinear beam axes but generally each beam propagates in the same direction in the same sequence near the optical path axis through common optical elements. The non-collinear beams are generally centered with respect to the entrance pupil of the laser processing lens so that beam positioning at each target position in the field of view is telecentric. As shown in FIG. 24, at the entrance pupil, each beam will propagate along a vector direction with an azimuth angle and an elevation angle relative to the lens axis. Laser spots, generally diffraction limited laser beam waists, formed at the focal plane of the lens at the array are offset from the lens axis with an orientation corresponding to the azimuth angle and a radial distance corresponding to the lens focal length times the elevation angle. The beam positioning system may include various adjusters for beam alignment, which may among other things, align the beams to the center of the entrance pupil of the processing lens.

U.S. Pat. No. 6,951,995, U.S. Publication 2002/0167581, and U.S. Pat. No. 6,483,071 disclose systems for beam positioning alignment, splitting, and the like as well as various material processing components, systems, and methods that can be used in conjunction with the inventions disclosed herein. Each of these documents is incorporated by reference herein and forms part of this disclosure.

1. In a laser based system for processing target material on a substrate, the system including a mechanical positioning system for moving the substrate along a processing trajectory relative to an aligned laser beam axis intersection position on or within the substrate, and a solid-state beam deflection system for addressing positions within an addressable field by deflecting the intersection position of the laser beam axis, the field including the aligned intersection position, the alignment relative to one or more features of the substrate, and the addressable field having an area and dimension relative to the aligned intersection position, a method of laser processing comprising:
moving the substrate along the processing trajectory,
deflecting the intersection position of the laser beam axis and the substrate to a position within the addressable field and offset from the trajectory,
impinging, at the deflected intersection position onto target material according to an offset dimension, one or more laser pulses occurring within a processing period that is synchronized with the trajectory and a sequence of targets to be processed,
wherein the trajectory and the sequence are determined based on target material locations, mechanical positioning parameters, and addressable field parameters, to generate the trajectory, the sequence of targets to be processed along the trajectory, and the corresponding offset dimensions.

2. The method of claim 1, wherein deflecting comprises acousto-optic deflecting.

3. The method of claim 1, further comprising calibrating addressable field deflection efficiency versus deflection angle.

4. The method of claim 3, wherein the field is calibrated in one axis.

5. The method of claim 3, wherein the field is calibrated in two axes.

6. The method of claim 1, wherein deflecting comprises solid-state deflection along axes non-orthogonal with the mechanical positioning axes.

7. The method of claim 6, wherein deflecting is in a direction transverse to the processing trajectory using multiple deflectors along multiple respective non-orthogonal axes, whereby the offset is a compound offset greater than a maximum deflection for any individual deflector.

8. The method of claim 1, further comprising imaging a first deflector pupil to a second deflector pupil with an optical relay.

9. The method of claim 8, further comprising picking-off zero order energy in each axis.

10. The method of claim 1, wherein deflecting comprises:
generating positioning commands for each processing period corresponding to the offset dimensions,
generating an amplified RF signal for each deflection axis responsive to the positioning commands and centered at an RF frequencies corresponding to the offset dimensions,
driving one or more acoustic transducers coupled to a Bragg diffraction cell with the signal to generate Bragg diffraction in the cell,
diffracting a portion the one or more laser pulses in the cell at a diffraction angle, the portion based in part on diffraction efficiency, and
controlling diffraction efficiency by adjusting at least one RF signal amplitude to maintain a selected laser pulse processing energy value.

11. The method of claim 10, further comprising forming at least one deflected spot with a controllable non-circular irradiance profile corresponding to the multiple frequencies in the RF signal.

12. The method of claim 11, further comprising forming a spot with different irradiance profile or orientation in a subsequent processing period.

13. (canceled)

14. (canceled)

15. The method of claim 1, wherein the velocity profile includes constant velocity segments.

16. The method of claim 1, wherein the laser processing rate is substantially constant and the velocity varies during processing according to the velocity profile,

17. The method of claim 13, wherein the velocity exceeds the numerical product of the processing repetition rate and a characteristic link pitch dimension divided by a number of rows addressed.

18. The method of claim 1, wherein the trajectory includes a mechanical positioning path that directs at least a portion of the addressable field over every target to be processed.

19. (canceled)

20. The method of claim 18, wherein the first target selected for processing in a trajectory segment may be processed by deflecting the beam to the leading edge of the field and the last target selected to be processed in the segment may be at the trailing edge of the field whereby for a predetermined velocity, a maximum number of processing periods can be utilized.

21. The method of claim 18, wherein the first target selected for processing in a trajectory segment may be processed by deflecting the beam to the trailing edge of the field and the last target selected to be processed in the segment processed may be at the leading edge of the field whereby for a predetermined number of processing periods, velocity is minimized.

22. The method of claim 18, wherein for successive targets, the distance in the field between respective successive offset dimensions in the field for each target with respect to the path has a direction opposed to the travel direction along the path and a magnitude greater that the distance traveled along the path between the associated successive processing periods, whereby the later impinged target precedes the earlier impinged target along the travel direction of the path.

23. The method of claim 1, wherein impinging comprises impinging on selected conductive links, each link having a length between conductive contacts and a width, and severing the conductive links across the width, between the contacts.

24. The method of claim 23, further comprising severing at least a first link having a width that is non-parallel with the trajectory.

25. The method of claim 24, further comprising severing at least a second link during a single trajectory segment, the second link having a width that is non-parallel with the first link width.

26. The method of claim 23, further comprising deferring impingement of at least one selected link for processing during different processing segment.

27. The method of claim 23, wherein impinging is impinging a single link in multiple processing periods with different offset dimensions.

28. The method of claim 1 further comprising determining a processing trajectory.

29. The method of claim 28, wherein determining is based at least in part on target density within the addressable field.

30. The method of claim 29, wherein determining includes maximizing the average link density within the addressable field over the trajectory.

31. The method of claim 28, wherein determining comprises determining a processing sequence for irregularly spaced links.

32. The method of claim 31, wherein the irregularly spaced links are clustered in high density areas.

33. The method of claim 1, wherein the area is a randomly addressed over 2 dimensions.

34. The method of claim 1, further comprising generating each offset dimension by:
identifying a link to be processed at the time of a pulse,
identifying the location of the aligned intersection position along the trajectory at the time of the pulse, and
determining the position of the link to be processed within the field at the time of the pulse, wherein the position within the field relative to the aligned intersection position at the time of the pulse is the offset dimension.

35. The method of claim 34, wherein determining the position of the link to be processed within the field at the time of the pulses includes determining an offset based in part on a mechanical position error signal, a laser pointing error signal or a blast timing correction value.

36. The method of claim 1, wherein the laser beam axis is aligned at a nominal pointing angle that substantially coincides with the center frequency of an AOBD and the optical axis of a focusing objective.

37. The method of claim 1 wherein impinging one or more pulses includes forming a spot with a single processing lens having a numerical aperture of NA 0.7 or greater and moving the lens to align a focal area in the field of view of the lens with a target.

38. The method of claim 1 wherein the field is at least 40 microns in diameter

39. In a laser based system for processing target material on a substrate, the system including a mechanical positioning system for moving the substrate along a processing trajectory relative to an aligned laser beam axis intersection position on or within the substrate, and a solid-state, beam deflection system for addressing positions within an addressable field by deflecting the intersection position of the laser beam axis, the field including the aligned intersection position, the alignment relative to one or more features of the substrate, and the addressable field having an area and dimension relative to the aligned intersection position, a method of laser processing comprising:
moving the substrate along the processing trajectory,
deflecting the intersection position of the laser beam axis and the substrate to a position within the addressable field and offset from the trajectory,
controlling energy delivered to the target material within a predetermined tolerance range relative to a selected processing energy value,
impinging, at the deflected intersection position onto target material according to an offset dimension, one or more laser pulses occurring within a processing period that is synchronized with the trajectory and a sequence of targets to be processed,
wherein deflecting comprises simultaneously deflecting the laser beam axis in a first axis and in a second axis and controlling comprises setting a processing energy value and adjusting beam attenuation according to a calibration profile.

40. The method of claim 39 wherein the calibration profile is a 2 dimensional diffraction efficiency profile.

41. The method of claim 39 wherein deflecting comprises deflecting the laser beam in a first axis with a first diffraction efficiency profile, and deflecting the laser beam in a second axis with a second diffraction efficiency profile, wherein the second diffraction efficiency profile is dependent on the first axis deflection.

42. The method of claim 39 wherein controlling energy further comprises setting a first processing energy value, setting a second processing energy value that is different from the first energy value, adjusting beam attenuation according to a first calibration profile associated with the first processing energy value, and adjusting beam attenuation according to a second calibration profile associated with the second processing energy value.

43. The method of claim 39 wherein controlling comprises calibrating a first deflector to generate a first calibration profile over the variables first deflection angle and processing energy.

44. The method of claim 43 wherein controlling comprises calibrating a second deflector to generate a second calibration profile over the variables first deflection angle and second deflection angle.

45. The method of claim 41 further comprising deflecting the laser beam in the first axis with a third diffraction efficiency profile, wherein deflecting with the first diffraction efficiency profile and the second diffraction efficiency profile correspond to a first processing energy value and deflecting with the third diffraction efficiency profile and the second diffraction efficiency profile correspond to a second processing energy value.

46. In a laser based system for processing target material on a substrate, the system including a mechanical positioning system for moving the substrate along a processing trajectory relative to an aligned laser beam axis intersection position on or within the substrate, and a solid-state beam deflection system for addressing positions within an addressable field by deflecting the intersection position of the laser beam axis, the field including the aligned intersection position, the alignment relative to one or more features of the substrate, and the addressable field having an area and dimension relative to the aligned intersection position, a method of laser processing comprising:
moving the substrate along the processing trajectory,
deflecting the intersection position of the laser beam axis and the substrate to a first position within the addressable field,
deflecting the intersection position of the laser beam axis and the substrate to a second position within the addressable field,
impinging, at the first position onto target material of a structure oriented in a first direction and according to an offset dimension, one or more laser pulses occurring within a processing period that is synchronized with the trajectory and a sequence of targets to be processed,
impinging, at the second position onto target material of a structure oriented in a second direction and according to an offset dimension, one or more laser pulses occurring within a processing period that is synchronized with the trajectory and a sequence of targets to be processed,
wherein the first and second positions are accessed along the trajectory in a single pass.

47. In a laser based system for processing target material on a substrate, the system including a mechanical positioning system for moving the substrate along a processing trajectory relative to an aligned laser beam axis intersection position on or within the substrate, and a solid-state beam deflection system for addressing positions within an addressable field by deflecting the intersection position of the laser beam axis, the field including the aligned intersection position, the alignment relative to one or more features of the substrate, and the addressable field having an area and dimension relative to the aligned intersection position, a method of laser processing comprising:
applying a first RF signal corresponding to a deflection angle to an acousto-optic beam deflector,
measuring diffraction efficiency versus time after applying the RF signal and determining a minimum propagation delay interval to achieve diffraction efficiency within a specified tolerance,
measuring diffraction efficiency versus time after terminating the RF signal at the end of an RF period and determining a minimum RF period to maintain diffraction efficiency within the specified tolerance,
moving the substrate along the processing trajectory,
deflecting the intersection position of the laser beam axis and the substrate to a position within the addressable field and offset from the trajectory by applying a second RF signal to the acousto-optic beam deflector using the minimum propagation delay and the minimum RF period,
impinging, at the deflected intersection position onto target material according to an offset dimension, one or more laser pulses occurring within a processing period that is synchronized with the trajectory and a sequence of targets to be processed.

48. A laser based system for processing target material on a substrate, the system including:
a laser source for generating one or more laser pulses occurring within each of a plurality of processing periods
alignment means for aligning the laser beam at an intersection position of the laser beam axis and the substrate relative to one or more features of the substrate on or within the substrate,
mechanical positioning means for moving the substrate along a processing trajectory relative to the aligned laser beam axis intersection position,
solid-state beam deflection means for addressing positions within an addressable field by deflecting the intersection position of the laser beam axis, the field including an aligned intersection position, the addressable field having an area and dimension relative to the aligned intersection position, and
control means for determining the processing trajectory and a sequence based on target material locations, mechanical positioning parameters, and addressable field parameters and for generating commands to move the substrate along the processing trajectory, to deflect the intersection position of the laser beam axis and the substrate to a position within the addressable field and offset from the trajectory, to impinge at the deflected intersection positions onto target material according to an offset dimension one or more laser pulses occurring within each of multiple processing periods synchronized with the trajectory and the sequence of targets to be processed.

49. A method of processing material of device elements by laser interaction, the elements distributed at locations about a workpiece, the method comprising:
generating a pulsed laser processing output along a laser beam axis, the output comprising a plurality of laser pulses triggered sequentially at times determined by a pulse repetition rate;
generating a trajectory relative to locations of device elements designated to be laser processed, said trajectory comprising a motion profile of an optical system axis intercept point at the workpiece;
driving relative motion of the intercept point and the workpiece along the trajectory;
predicting the position of one or more designated device elements relative to the intercept point position on the trajectory at one or more laser pulse times;
deflecting the laser beam axis relative to the optical system axis to sequentially offset focused laser spots from the intercept point within a predetermined deflection range based on the predicted position; and
irradiating the designated elements with pulses from the laser output at the offset laser spots, wherein the elements are conductive links of electronic devices, the workpiece is a semiconductor substrate and processing comprises severing designated links.

50. The method of claim 49, wherein the elements are distributed at locations characterized by row and column coordinates of an aligned array and wherein deflecting comprises deflecting in at least two axes to offset the laser spots to designated row and column element locations.

51. The method of claim 49, wherein the elements are distributed at locations that are not characterized by row and column coordinates, and wherein the trajectory is time optimized to efficiently process designated elements.

52. The method of claim 49, wherein the laser pulse repetition rate is greater than the motion velocity divided by the link pitch.

53. The method of claim 49, wherein generating a pulsed laser processing output comprises triggering a laser at a constant repetition rate.

54. The method of claim 49, wherein generating a trajectory comprises generating motion profile segments for groups of elements and generating motion profiles between groups of elements.

55. The method of claim 49, wherein generating a trajectory comprises receiving locations of elements designated for processing, grouping elements into processing groups, determining a velocity profile and an intercept point track for each group, and determining velocity profiles and intercept point tracks between groups.

56. The method of claim 49, wherein the motion profile comprises different velocity segments, each segment velocity greater than the row link pitch divided by the pulse repetition rate further divided by the number or rows, the velocity less than a predetermined maximum velocity, whereby throughput is increased and accuracy is maintained.

57. The method of claim 49, wherein the optical system axis comprises an objective lens axis.

58. The method of claim 49, wherein the optical system axis comprises a calibrated deflection field coordinate.

59. The method of claim 49, wherein driving comprises controlling at least one motion stage carrying the workpiece.

60. The method of claim 49, wherein driving comprises measuring position data at timing intervals exceeding the constant laser repetition rate.

61. The method of claim 49, wherein predicting comprises processing a stored history of positions and sampling times and estimating a position for a future pulse.

62. The method of claim 49, wherein the future pulse is scheduled at or less than the pulse repetition period.

63. The method of claim 49, wherein the future pulse is scheduled greater than one pulse period away.

64. The method of claim 49, wherein the future pulse is scheduled greater than the acoustic fill time of the deflector.

65. The method of claim 49, wherein deflecting comprises comparing the offsets to the deflection range, and blocking pulse transmission when the predicted position is not within the deflection range.

66. The method of claim 49, wherein deflecting comprises calculating offsets for the predicted position.

67. The method of claim 66, wherein calculating comprises calculating offsets in less than one pulse to pulse period.

68. The method of claim 66, wherein calculating comprises calculating offsets in less than 10 micro seconds.

69. The method of claim 66, wherein calculating comprises calculating offsets in less than 3.5 micros seconds.

70. The method of claim 66, wherein calculating comprises geometrically correcting a deflection angle to produce a desired offset value on the workpiece.

71. The method of claim 66, wherein calculating comprises modulating transmission.

72. The method of claim 49, wherein deflecting comprises generating RF signals at a predetermined times corresponding to a subsequent laser trigger times and applying the RF signals to at least one transducer of at least one acousto-optic deflector, each RF signal having one or more frequency corresponding to a deflection field coordinate, an amplitude corresponding to a transmitted pulse energy, a start time accommodating for propagation delay of an acoustic wave traveling from a transducer to an acoustic window and a duration sufficient to fill the acoustic window with the traveling acoustic wave.

73. The method of claim 49, wherein deflecting further comprises applying a first RF signal at a first time corresponding to a first laser trigger time and applying a second RF signal at a second time, the second time preceding the first laser trigger time.

74.-85. (canceled)
